(19) United States
(12) Patent Application Publication
(10) Pub. No.: US 2002/0111934 A1
(43) Pub. Date: Aug. 15, 2002

(54) Question associated information storage and retrieval architecture using internet gidgets

(76) Inventor: Shankar Narayan, Sunnyvale, CA (US)

Correspondence Address: HICKMAN PALERMO TRUONG & BECKER, LLP, 1600 WILLOW STREET, SAN JOSE, CA, 95125, US

(21) Appl. No.: 09/981,340

(22) Filed: Oct. 16, 2001

Related U.S. Application Data
(60) Provisional application No. 60/241,447, filed on Oct. 17, 2000.
(60) Provisional application No. 60/241,273, filed on Oct. 17, 2000.

(51) Int. Cl. G06F 7/00

(52) U.S. Cl. 707/1

(57) ABSTRACT

Approaches are described for improving the storage and retrieval of information. The approaches are based on a questioned based model where, in response to receiving data representing a question, information is retrieved that may answer those questions. Specifically, a question base server stores records, each record representing a question and a location of an information source for that question. The information source may be a file on a web server or a database that resides on a web server. Input representing a question is transmitted by a client to a web server. The web server transforms the input into a form that may be processed by the question base server. The question base server receives the transformed input and selects records that store information sources for the question. A list of selected records is transmitted back to the client.

### RELATED APPLICATIONS

This application claims priority to U.S. Provisional Patent Application No. 60/241,447, entitled “Internet Widgets and an Architecture to Create Integrated Service Ecosystems Using Internet Widgets”, filed by Shankar Narayan on Oct. 17, 2000, the contents of which are incorporated by reference in its entirety.

This application claims priority to U.S. Provisional Patent Application No. 60/241,273, entitled “Question Associated Information Storage and Retrieval Architecture Using Internet Gidgets”, filed by Shankar Narayan on Oct. 17, 2000, the contents of which are incorporated by reference in its entirety.

This application is related to the United States Patent Application entitled “Pluggable Instantiable Distributed Objects”, attorney docket number 60033-0012, filed on the equal day herewith by Shankar Narayan, the contents of which are herein incorporated by reference in its entirety.

This application is related to the United States Patent Application entitled “Synchronized Computing With Internet Widgets”, attorney docket number 60033-0011, filed on the equal day herewith by Shankar Narayan, the contents of which are herein incorporated by reference in its entirety.

### FIELD OF THE INVENTION

The present invention is related to distributed computing in a network environment.

### Application Overview

1.0 Introduction:

In this document, I describe an information storage and retrieval technology that has several advantages over any of the known solutions of similar kind. The advantages of this technology are quite numerous and I will describe at a very high level the benefits of productizing this technology and hence the problem that will be solved for the users of this technology. In summary, the technology solves the following problem:

This technology improves the following attributes of the economics of digital information (such as text, images, software, video, audio, and closed information that is not published)

Enhanced information efficiency (amount of time needed to obtain the information sought)

Reduces the risk component in forecasting supply and demand characteristics of economic good.

Improve information availability based on the market forces for information

Tracking plagiarized & illegal dissemination of information

Improved access of closed information (such as books)

Fine grained sale of the information published etc.

Completes the information creator and retriever loop to constantly enhance the quality of the information

For more detailed analysis on the basis for how we arrived at the above conclusions the reader is referred to the document “The effectiveness of QAISR based information retrieval engines” [SHAN00a]. The above described problems are solved by using a combination of two architectures called “Question Associated Information Storage and Retrieval architecture”, and “Internet Gidgets”. The primary focus of this document is to describe the QAISR architecture in detail, and describe what “Internet Gidgets” are and how the combination of the QAISR architecture and the “Internet Gidget” model together help in solving the above described problem.

The beneficiaries of this technology are the various participants in the information life cycle, namely the information creators, the information consumers/retrievers, and information managers. In this document we present the architecture in detail, and enumerate in the presentation of the architecture various benefits to the various participants in the information life cycle.

This technology has applications in helping information creators, be that open information such as text, free published digital images, free published digital videos, free digital music & free software applications or closed information (that is not for fee but for a price) such as books, digital/analog music, digital/analog videos, product related information, digital data hidden in databases etc. It helps the information creators improve the ability of information consumers to find the created information with a natural language interface that is amenable to voice driven user interface. In the introduction we will describe the structure of the rest of this document, an overview of the problem being solved and an overview of the QAISR architecture.

1.1 Structure of the Document:

We will present our discussion in the following order:

1. Introduction

2. Historical precursors

3. Primary innovative design principles behind the architecture.

4. Organization of all digital information in QAISR view

5. Meta data format

6. The specification of QB and the associated interfaces

7. Information creation

8. Information management

9. Internet gidgets

10. Information retrieval

11. Complete Architecture

12. Implications of QAISR architecture

13. Security in QAISR architecture

14. Applications of QAISR/Internet gidgets

15. Some conclusions

### BACKGROUND

1.2 Overview of the Problem Being Solved and Some Background:

In this subsection we will provide some background for describing the problem and in the end describe the problem that we are trying to solve. One of the significant human accomplishments is to share information. In order to share information, we have to have information creators and consumers. Information creator and the consumer of some information can be the same individual. Information consumption can happen in two different ways: push and pull.

In push consumption, some one who is the information creator or a person that consumed the information previously makes the information consumer consume the information. This form of information consumption happens when the consumer is willing to consume the information being pushed. Historically this has been done by people on a person to person basis, or person to group basis where a single speaker or writer made an individual or a group consume the material created by them. In today's world this happens through media such as television, internet where the information consumer tunes in a channel and allows the pushing of information.

In the pull form of information consumption the consumer actively tries to find the information that he/she intends to consume. Historically the ways in which consumers were helped in finding information has changed. Techniques such as asking some people that they know, to going to libraries to use catalogues, to using search engines have been used in finding the information that would help the consumer. In this sub-section, we will describe how information creation, and information consumption have happened over time. We will subsequently describe how techniques were devised to help pull consumers or information retrievers find the information. And then we will present the principle idea that improves the ability of information retrievers find the information that will help them.

1.2.1 Information Creation & Consumption

Historically human information creation involved information creation using the following techniques:

a. speaking

b. free form writing

c. structured writing

d. analog recording of physical phenomenon such as sound, static pictures, moving pictures

e. structured digital data creation and software applications

f. information encapsulated in products

Each of the above techniques provided some benefit that was not provided by the other techniques and hence they have found wide usage.

1.2.1.1 Information Creation by speaking

Information creation using the ability to speak made it possible for people to store information in their human brains and share information with a willing consumer without needing anything more than themselves. The disadvantage with this technique is that an individual is limited by their human capacity to remember in order to share the information with themselves or others. The other disadvantage of this technique is that the speaker has to be near (within the ear shot) the consumer to share the information. Also, people can only consume information if the people that they interact with have consumed or originally created the information.

1.2.1.2 Information Creation by Free Form Writing

This technique involves people creating information by writing in one of the several languages. This technique has the advantage over speaking where more information than can be held in a human brain can be created. The creator need not be near the consumer or know the consumer for the consumer to be able to consume information, in effect making information more mobile. Also, the words used for communication do not change in speaking and writing and thus the human ability of remembering language is adequate to consume the information. One of the disadvantages of this technique is that it like in speaking may lose some of the details of the raw information that is being described in the writing. When the written material is small, it is easy to find the information. However, if the material is large it is usually difficult for the consumer of information to find what is of interest to the finder. In order for a consumer to find what she is looking for, the consumer may have to read all the written material.

1.2.1.3 Information Creation by Structured Writing

In structured writing, the information creator uses some structure that will help them find the information. For instance, the information creator may use an address book to store all the addresses. This will make it easy for the information creator to find all the addresses. The consumer needs to remember where the addresses have been stored. Similarly, it is possible for the information creator to create an index for the written material, or create a card catalog as some techniques that will help the information consumer find the created information. The created information still has the disadvantage of potential loss of information in translating real phenomenon into the written word.

1.2.1.4 Information Creation by Analog Recording

Through out history human beings have created devices to capture and record real life events such that there is minimal loss of data in recording these events. These device range from, audio, video recording devices to oscilloscopes etc. These have the advantage of not losing any information in transforming the data into spoken/written language. However, to understand or find this information human beings still need to use their capacity to comprehend language. To understand they need to read the description of how the recording and playback can be performed. To find the information humans still need to use the capacity that they have to enquire for this information.

1.2.1.5 Information Creation by Structured Digital Data Creation and Software Applications

In more recent times, the advances in computing have made it possible for people to create information that is structured to derive several advantages in doing so. For one more information can be represented using techniques that allow software applications to visualize the information. Operations can be defined on the created information that lead to additional information. The operations could be sorting, merging etc. This structured digital information may be created from existing information that has been created in other forms or it is directly created using software applications that help in the creation of information. The disadvantage with most of these applications is that the application that has been used to create the information is needed to find the information managed by the application. In other words, if a creator uses 15 applications and creates hundreds of pieces of information, and there are millions of information creators using 15 sets of applications, then the consumer does not have an easy way to find the information that the consumer is interested in finding. Also, the user interfaces that are used by software applications tend to be different for each application and a user to find what he or she may be trying to find will have to interact with these various disparate interfaces even if the information they are looking for is not in the data that has been created by these disparate applications.

1.2.1.6 Information Encapsulated in Products and Objects

It is not a stretch to say that products and objects encapsulate information that is created and this information as well as the product are consumed and retrieved by people all the time. Typically consumers of such information need to enquire some one who may know where to find a product or object, or use written catalogs to discover these objects and products.

1.2.2 Information Finding

As information has been created over time, various techniques have been used to assist in finding information by potential consumers. Also, the improvements in technology contributed to changes in the possibilities for facilitating consumption, as well as changes to the target consumers of information. In this section we will enumerate the eras technologies and corresponding changes in possibilities as well as the target consumers. For each of these eras we will identify the techniques that were used in helping consumers find information.

1.2.2.1 Pre Book Era

1.2.2.1.1 Possibilities

In this era the possibilities for information consumption based on the technology were very limited. Speakers with wisdom spoke to the people that were physically proximate.

1.2.2.1.2 Scope of Target Consumers

People in the vicinity.

1.2.2.1.3 Techniques for Helping Consumers Find Information

People asked each other about who may have information that may benefit them using questions.

1.2.2.1.4 Problems With the Techniques

In order to find the person with the information, you may have to ask the question to every person in the vicinity directly or indirectly.

1.2.2.1.5 Techniques Used by Consumers to Find Information

1.2.2.1.5.1 Asking Someone a Question That May Elicit the Information or the Written or Digital Source of Information is Still in Vogue

1.2.2.1.5.2 Find Information About Products and Objects Using the Above Technique

1.2.2.2 Books and Library Era

1.2.2.2.1 Possibilities

In this era it was possible to maintain warehouses of information. As the same book was purchasable by any community with resources it was possible to house all the written information within the vicinity of all the people.

1.2.2.2.2 Scope of Target Consumers

With the advent of books and libraries, theoretically every person on this planet was a potential target consumer of the information created. However, in practical terms the consumer had access to the written resources that were sold in their vicinity.

1.2.2.2.3 Techniques for Helping Consumers Find Information

Some of the techniques used for finding information are:

1.2.2.2.3.1 Asking Someone a Question That May Elicit the Information or the Written Source of Information

1.2.2.2.3.2 Structure Information in a Way it is More Easily Found, by Creating Address Books etc.

1.2.2.2.3.3 Information Creators Create Word Indices and Card Catalogs That Helped People Find Related Information.

1.2.2.2.4 Problems With the Techniques

There may be a lot of information that exists but is not discovered by a consumer due to any of the following reasons:

1.2.2.2.4.1 The Books and Libraries in the Neighborhood do not Contain the Information Sought

1.2.2.2.4.2 Cannot Pose a Question That States Exactly What the Consumer Wants to Find in the Books

1.2.2.2.4.3 The Index/Catalog Skips the Particular Topic of Interest to the Consumer

1.2.2.2.4.4 It is Difficult to Ask All the People That May be Knowing the Information Sought by the Consumer.

1.2.2.2.4.5 It is Difficult for Consumers to Find Un-Indexed Text Material

1.2.2.2.5 Techniques Used by Consumers to Find Information

1.2.2.2.5.1 Asking Someone a Question That May Elicit the Information or the Written or Digital Source of Information is Still in Vogue

1.2.2.2.5.2 Use Book and Library Indices to Find Information

1.2.2.2.5.3 Find Information About Products and Objects Using the Above Techniques From the Information That Describes the Products and Objects.

1.2.2.3 Un-Networked Digital Computer Era

1.2.2.3.1 Possibilities

With the advent of digital computers it became possible to process inordinate amounts of text to create indexes automatically. Due to the enormous storage capacity of a digital computer it became possible to store tremendous amount of information, and thus constructing huge buildings that are very expensive was not necessary to house information. It also became easy to store information and process information to create more useful information as long as the stored information was local and the application that interprets and processes the information is discovered and used by the information consumer.

1.2.2.3.2 Scope of Target Consumers

With un-networked computers, the scope of consumers remained the same in terms of vicinity dictating what created information is available for consumption. It is the quantity of information that is available for consumption.

1.2.2.3.3 Techniques for Helping Consumers Find Information Some of the Techniques Used for Finding Information are:

1.2.2.3.3.1 Asking Someone a Question That May Elicit the Information or the Written or Digital Source of Information is Still in Vogue

1.2.2.3.3.2 Structure Information in a Way it is More Easily Found, by Creating Address Books and the Associated Applications etc.

1.2.2.3.3.3 Information Creators use Software to Create Word Indices and Card Catalogs That Helped People Search and Find Related Information.

1.2.2.3.3.4 The Individual Applications Provided Ways to Find Useful Information From the Information Stored in Their Storages.

1.2.2.3.4 Problems with the Techniques

There may be a lot of information that exists but is not discovered by a consumer due to any of the following reasons:

1.2.2.3.4.1 The Digital Computers, Books and Libraries in the Neighborhood do not Contain the Information Sought

1.2.2.3.4.2 Cannot Pose a Question That States Exactly What the Consumer Wants to Find in the Books & Computers as one Would Ask a Fellow Human Being That has the Information.

1.2.2.3.4.3 The Index/Catalog Algorithm Could Skip the Particular Topic of Interest to the Consumer are the Large Volume of Information May Lead to too Numerous un Related Information Associated With the Topic.

1.2.2.3.4.4 The Indexing Technique While Optimal For Pre-Computer Era is Replicated as is in the Computer Era and is Limited When the Amount of Information is Greater by Orders of Magnitude.

1.2.2.3.4.5 It is Difficult for the Consumer to Ask all the People That May be Knowing Where to Find the Information Sought by the Consumer.

1.2.2.3.4.6 It is Difficult to Find Information When Several Different Applications Create the Data and Each Application has to be Invoked Several Times to Scan All the Stored Information to Find the Information.

1.2.2.3.4.7 It is Difficult to Find Information That is Encapsulated in Products and Objects.

1.2.2.3.4.8 If Information was Stored in Multiple Computers the User Needed to Find All the Computers to Exhaust Potential Places to Find the Information of Interest.

1.2.2.3.4.9 The Applications Used by Information Creators That Generate and Store Data do not at Creation Time do Anything That is Directly Targeted to Help Potential Consumers in Finding the Information.

1.2.2.3.5 Techniques Used by Consumers to Find Information

1.2.2.3.5.1 Asking Someone a Question That May Elicit the Information or the Written or Digital Source of Information is Still in Vogue

1.2.2.3.5.2 Use Book and Library Indices to Find Information

1.2.2.3.5.3 Use Computer Generated Indices to Find Text Based Information

1.2.2.3.5.4 Scan All the Computer Data Created Using the Different Applications That Created the Data to Find Non-Textual Information

1.2.2.3.5.5 Find Information About Products and Objects Using the Above Techniques From the Information That Describes the Products and Objects.

1.2.2.4 Internet Era

1.2.2.4.1 Possibilities

The advent of internet made it possible for anyone in the planet to access any information anywhere. It also made possible for some specialized finding techniques such as search engines that indexed all the publicly accessible text information accessible on the internet increasing the chance of a consumer finding the information of interest.

1.2.2.4.2 Scope of Target Consumers

Vicinity of the location of residence of the information was no more a factor in locating information. Every person with access to the internet can access information for public consumption on the internet if they can find it. As the significance of the information that is accessible is proportional to how easily it is found by the people seeking the information, the information creators benefit by investing in improving the findability of the information created by them.

1.2.2.4.3 Techniques for Helping Consumers Find Information Some of the Techniques Used for Finding Information are:

1.2.2.4.3.1 Asking Someone a Question That May Elicit the Information or the Written or Digital or Internet Source of Information is Still in Vogue

1.2.2.4.3.2 Structure Information in a Way it is More Easily Found, by Creating Address Books and the Associated Applications That are Bound to a Computer or Internet Applications etc.

1.2.2.4.3.3 Information Creators use Software to Create Word Indices and Card Catalogs That Helped People Search and Find Related Information.

1.2.2.4.3.4 Search Engines Create Indices of All Accessible Information Over the Internet to Help Users Find Information Using Keywords.

1.2.2.4.3.5 The Individual and Internet Applications Provided Ways to Find Useful Information From the Information Stored in their Storages.

1.2.2.4.4 Problems With the Techniques there May be a Lot of Information That Exists But is Not discovered By a Consumer Due to Any of the Following Reasons:

1.2.2.4.4.1 Cannot Pose a Question That States Exactly what the Consumer Wants to Find in the Internet, Books & Computers as One Would Ask a Fellow Human being That Has the Information. (Technology Used By a Company Called ask.com Make the User ask Question But Use the Words in the Question as Search Engine Would Use Key Words. Also, There is No Necessary Correlation With the Questions Asked and the Answers Provided)

1.2.2.4.4.2 the Index/Catalog Algorithm of the Search Engine Could Skip the Particular Topic of Interest to the Consumer Are the Large Volume of Information May Lead to too Numerous Un Related Information associated With the Topic.

1.2.2.4.4.3 the Indexing Technique Used in Search Engines While Optimal For Pre-Computer Era is Replicated as is in the Computer and Internet Era and is Limited When the Amount of Information is Greater by Orders of Magnitude.

1.2.2.4.4.4 It is Difficult to Ask All the People That May be Knowing Where to Find the Information Sought By the Consumer.

1.2.2.4.4.5 It is Difficult to Find Information When Several Different Software and Internet Applications Create the Data and Each Software and Internet Application has to be invoked Several Times to Scan All the Stored Information to Find the Usable Information. On the Internet There Are so Many Sources of Information That It is Practically Impossible to Scan All the Digital Data That Drives the Internet Sites to Find the Information.

1.2.2.4.4.6 It is Difficult to Find Information That is Encapsulated in Products and Objects.

1.2.2.4.4.7 the Internet and Computer Applications Used by Information Creators That Generate and Store Data Do Not at Creation Time do Anything Significant That is Directly Targeted to Help Potential Consumers in Finding the Information.

1.2.2.4.5 Techniques Used by Consumers to Find Information

1.2.2.4.5.1 Asking Someone a Question That May Elicit the Information or the Written or Digital Source of Information is Still in Vogue

1.2.2.4.5.2 Use Book and Library Indices to Find Information

1.2.2.4.5.3 Use Computer Generated Indices to Find Text Based Information

1.2.2.4.5.4 Scan All the Computer Data Created Using the Different Applications That Created the Data to Find Non-Textual Information

1.2.2.4.5.5 Use a Search Engine to Find Text Based Information That is Accessible Over the Internet

1.2.2.4.5.6 Scan All the Computer Data Created Using the different Internet Applications That Created the Data to Find Non-Textual Information

1.2.2.4.5.7 Find Information About Products and Objects Using the Above Techniques From the Information That Describes the Products and Objects.

1.2.3 Information Finding Problem and the Solution Proposed

From the above analysis, we identify the problems that will be solved by using the QAISR and Internet Gidget technologies that are not solved by the contemporary state of the art in the technologies of information creation and information finding. We identify the objectives of the proposed technologies such that they will solve the problems identified.

1.2.3.1 The Problem:

The problem we are solving is to create a technology that makes it possible for Interested information creators that create information of all types to improve the findability of the information created by them by as many consumers that need the information as possible. Also, we are attempting to solve the problem in such a way that it makes it possible for information consumers to need as little expertise in the technology and tools used by information creators in finding the information that they need by posing questions in natural language that lead them to the information of their interest while minimizing the number of applications and web-destinations that they need to visit in order to find the information and it provides a mechanism to evaluate the usefulness of information as valued by the consumer. By solving the above problems we will build the infrastructure that enables us to track illegitimate distribution of digital information.

1.2.3.2 Objectives:

As a question asked by an information consumer best abstracts what a user is seeking, the goal of the proposed solution is to make it possible for information consumers to find the information that they seek.

Make it possible for information consumers to not hop to multiple internet applications to find information that is both raw text as well as data created by applications.

Make it possible for information creators to improve the findability of the information that is created by them.

Make it possible for information consumers to find information that will help them locate products and objects using the same technique described above.

### SUMMARY OF THE INVENTION

Approaches are described for improving the storage and retrieval of information. The approaches are based on a questioned based model where, in response to receiving data representing a question, information is retrieved that may answer those questions. According to an aspect of the present invention, a question base server stores records, each record representing a question and a location of an information source for that question. The information source may be a file on a web server or a database that resides on a web server. Input representing a question is transmitted by a client to a web server. The web server transforms the input into a form that may be processed by the question base server. The question base server receives the transformed input and selects records that store information sources for the question. A list of selected records is transmitted back to the client.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram depicting elements that participate in the creation and storage of information according to an embodiment of the present invention;

FIG. 2 is a block diagram depicting a tree hierarchy in a question base used to manage information according to an embodiment of the present invention;

FIG. 3 is a block diagram depicting a user interaction stage of an information retrieval process according to an embodiment of the present invention;

FIG. 4 is a block diagram depicting a transformation stage of an information retrieval process according to an embodiment of the present invention;

FIG. 5 is a block diagram depicting a process for retrieving information from a question base according to an embodiment of the present invention;

FIG. 6 is a block diagram depicting a parameterized information creation process according to an embodiment of the present invention;

FIG. 7 is a block diagram depicting a parameterized information creation process according to an embodiment of the present invention;

FIG. 8 is a block diagram depicting a physical object question associated information storage and retrieval architecture according to an embodiment of the present invention;

FIG. 9 is a block diagram depicting a user interface element integrated as part of a web page according to an embodiment of the present invention;

FIG. 10 is a block diagram depicting a question associated information and storage retrieval architecture using internet gidgets according to an embodiment of the present invention;

FIG. 11 is a block diagram depicting a question associated information and storage retrieval architecture according to an embodiment of the present invention;

FIG. 12 is a block diagram depicting a question associated information and storage retrieval architecture according to an embodiment of the present invention;

FIG. 13 is a block diagram depicting a question associated information and storage retrieval architecture using an internet and intranet according to an embodiment of the present invention;

FIG. 14 is a block diagram depicting a question associated information and storage retrieval architecture from the perspective of an individual information creator according to an embodiment of the present invention;

FIG. 15 is a block diagram depicting a process that reduces the number of hops a user performs to find useful information according to an embodiment of the present invention;

FIG. 16 is a block diagram depicting differences between conventional search processes and searches that can be performed using the question associated information and storage retrieval architecture;

FIG. 17 is a block diagram depicting question associated information and storage retrieval architecture tailored for an online music vendor according to an embodiment of the present invention;

FIG. 18 is a block diagram depicting question associated information and storage retrieval architecture tailored for an online music vendor according to an embodiment of the present invention;

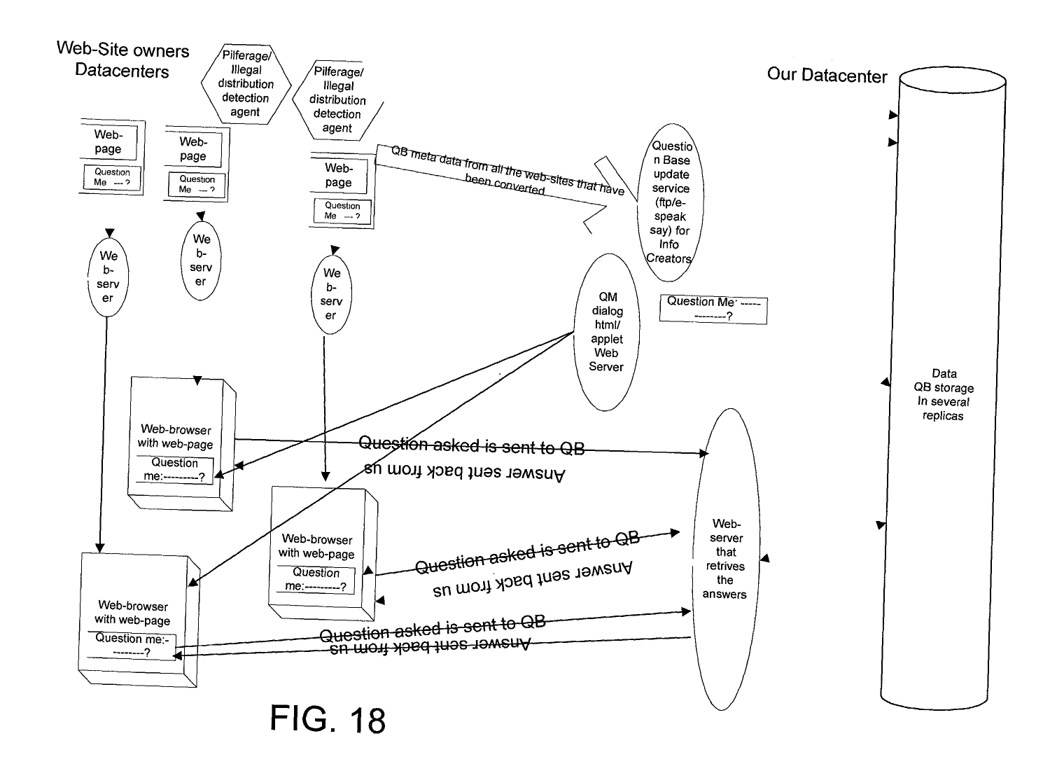

FIG. 19 is a block diagram depicting a question associated information and storage retrieval architecture that uses an unpartitioned QB according to an embodiment the present invention;

FIG. 20 is a block diagram depicting a question associated information and storage retrieval architecture that uses a partitioned QB according to an embodiment the present invention;

FIG. 21 is a block diagram depicting a question associated information and storage retrieval architecture that uses dynamic load balancing according to an embodiment the present invention; and

FIG. 22 is a block diagram depicting a computer system upon which an embodiment of the present invention may be implemented.

### DETAILED DESCRIPTION

A method and apparatus for information storage and retrieval architecture is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1.3 Overview of the Architecture:

QAISR architecture that modifies the information creation step, makes it possible for the information creators that would like to improve the findability of the information created by them. It also facilitates the consumer to use natural language questions to find information.

Internet gidget technology in conjunction with the QAISR architecture makes it possible for information retrievers to find the information by not having to traverse multiple locations to find the information sought by them.

Question Associated Information Storage Retrieval (QAISR) is an architecture that improves user ability to retrieve the information that they seek. This improvement is measured in terms of time and ease of use. The QAISR architecture can be partitioned into three well defined architectural elements. Each architectural element is characterized by the work-flow of tasks that facilitate the complete solution. The three distinct sets of work-flows that are needed for the solution are:

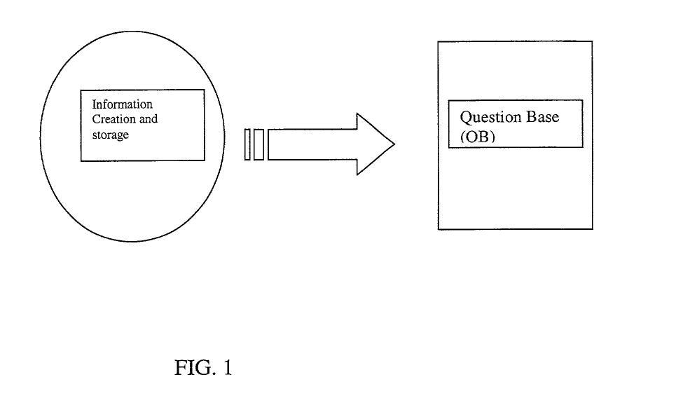

Information creation & storage, as shown by FIG. 1.

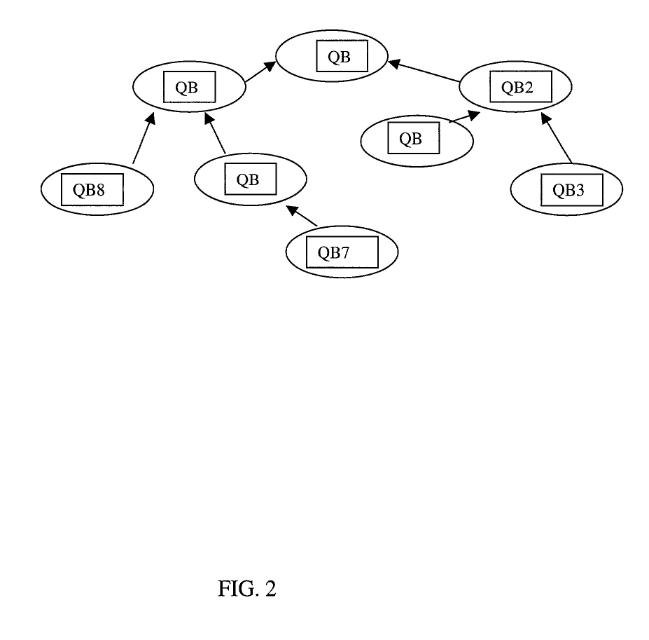

Information management, as shown by FIG. 2.

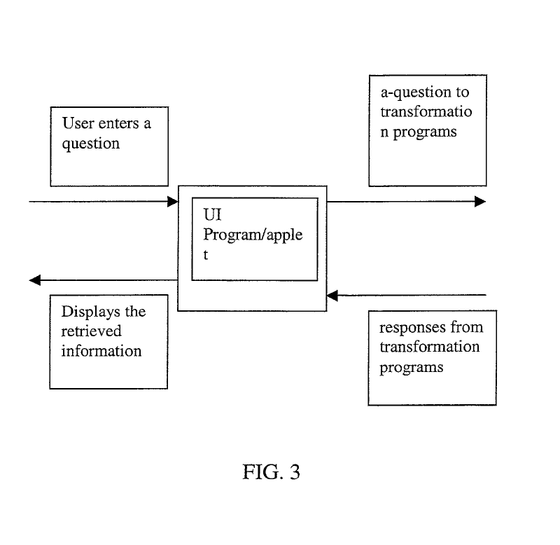

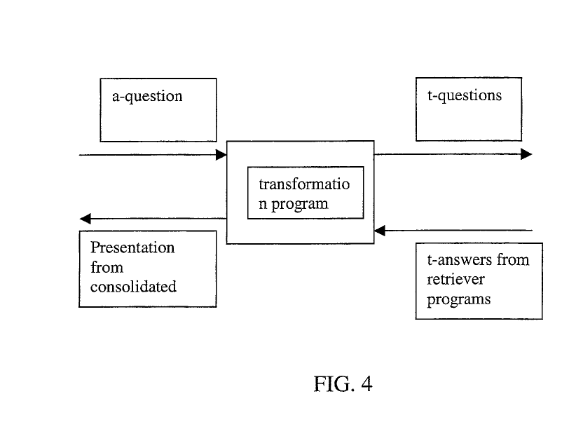

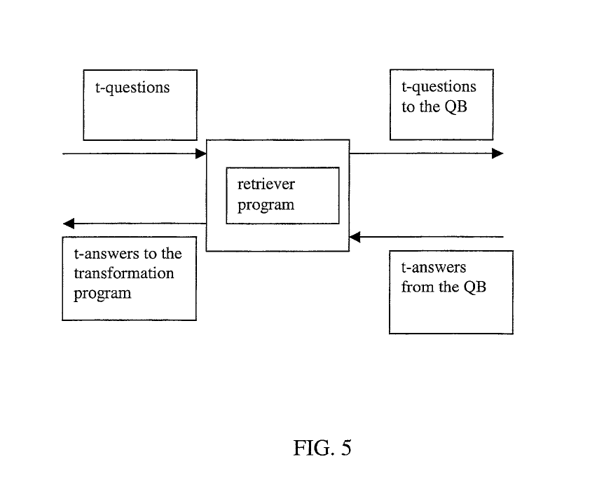

Information retrieval, as shown by FIG. 3, FIG. 4, AND FIG. 5.

The information retrieval has the three stages depicted in the three figures below:

FIG. 3—The UI interaction stage.

FIG. 4—The transformation stage.

FIG. 5—The retrieval from the QB stage.

The three components that comprise of the Question Associated Information Storage and Retrieval (QAISR) architecture are briefly described in the overview. A more elaborate description of the architectures of these components is presented in sections dedicated for these architectures. We describe the internet-gidget software model in the information retrieval section. This document about QAISR architecture provides the framework for constructing several very effective information access solutions. We enumerate these solutions.

This work relies on the axiomatic premise that all or any information (not just textual information, but all kinds of information including software application usage, audio, video, and closed information that is not published—such as books) is an answer to some or many questions, and the fastest way to retrieve the answer is by using the questions as indices for retrieving the information. Another objective of this technology is to make it possible for ubiquitous access to information (i.e they should be able to get the information from any internet-location), and all the user needs to do is compose a question that corresponds to the information that user is interested in. One should distinguish, composing answers to questions asked with composing plausible questions for any given information which is at the crux of this architecture. To facilitate easy retrieval of information, QAISR architecture relies on binding all (or necessary) information (or references to information as some times the information could be closed and only the email address of the contact that can supply the answer is bound to the question) to as many questions that elicit the information as an answer. A universal repository is maintained that holds all the questions and the location of the information (or reference to the information) associated with the question. When a user needs some information, the user formulates a question and supplies it to the user interface of the QAISR internet gidget that in turn looks up the location of the answer and presents a meaningful response. The first component of the three components of the architecture specifies the various elements required for information creation in such a way that as part of information creation the creators also generate questions and the associated meta data that are meaningfully associated with the information that is being created. In this component, the specification for the storage of the meta information comprising of the questions and the location of the information is also done. The second component of the architecture designs the components that make it possible for the meta data generated by the info creators to be coalesced into a single repository (the repository could be distributed). Finally, the third component designs the info retrieval part of this solution. The info retrieval is architectured using an innovative software component called internet gidget. The info-retrieve section has a detailed description of what an internet-gidget is and what the benefits of such a component are. All the three modules interact with each other, and the interaction happens through a question base (QB). The architecture of the question base is described as part of the description of the information creation architecture.

The information creation process binds one or more questions to the location of the information or the reference to the location of the information. For any given piece of information there is a corresponding set of [q,l,a] triplets, where “q” is the question, “1“the location and “a” set of attributes of significance. Any collection of [q,l,a] triplets is called a question base or QB. In effect, the information creation process generates several [q,l,a] triplets from a given body of information or when creating new information. All the three components of creation, retrieval and management of information interact with a QB. The three components also are based on the way all digital information is viewed in the QAISR architecture.

2.0 Historical Precursors

The general problem of helping an information seeker locate the information that is being sought by the user is a problem that engages academic and commercial researches ever since people have started creating abundant amounts of information. This problem has its genesis prior to the contemporary explosion of information. From the times when libraries have created card catalogues to help information seekers locate the information that they are seeking to contemporary general purpose search engines several techniques have been devised to address this problem with varying degrees of success. Leading research continues to take place in this area with the problem attacked from multiple biases. A near comprehensive survey of the recent advances in this pursuit can be found in these books and articles [AGGR92], [RIBE99], [SELA98], [JUHE98], [WIFR94]. Some of the prominent research efforts in solving this problem are focused in the following areas: 1. Message Understanding and 2. Information extraction.

Message Understanding:

Message understanding (MUC) conferences, indicate that the researchers are attempting to create summaries of the messages that they process to enable info retrievers to better select the retrieved documents using the summaries [JOJO95], [AMIT98].

Information Extraction:

There is an attempt to process the messages and text to create database content that will then be used for database like queries on information. For instance, a job database is created from the classified advertisements in text form for one to facilitate querying of the database. These databases tend to be for special purposes and do not solve the most general problem that we attempt to solve [CAGA92].

Among the commercially used solutions that solve the most generic information retrieval problem (less generic than the problem solved by QAISR), several heuristics and AI techniques form the basis for the strategies used by these corpus consuming search methodologies.

Additional research is being conducted to make it possible for people to search images/video [BAFU96] and other digital formats with specialization in those formats. All of these strategies have merit in solving the specific problem that they attempt to solve but none of them propose a strategy that attempts to solve the problem as articulated in the introduction section of this document. Besides helping solve several of the problems solved by these other strategies, the QAISR architecture solves some problems that are uniquely solved using the QAISR architecture. The rest of this document describes the QAISR architecture methodology and presents all the consequent advantages in using this technology.

3.0 Innovative Design Principles:

In data processing, there are two ways to improve the performance characteristics of any software operating on a set of data. One is to improve the algorithms that operate on the generic data to get better performance, and the other is to organize data in an intelligent way to help the algorithms to improve the performance of the software, without extraordinary effort. An analogous comparison would be to the difference between searching for a number in a random list, and keeping a list always sorted and searching the number in that list.

The philosophy of organizing the data to improve the ability to find the information is the driving design principle behind this architecture. Our approach to data organization is to bind data to the various questions that can elicit this data as a response to these questions. And we use the question as the index to retrieve the information.

The second innovative approach is to use the abstraction of internet-gidget which makes it possible to bind the functionality of information creation and information retrieval to the applications and information that is being operated on. It enables information created by any one to be accessible to every one by just asking the right question at any web-site that presents the UI of the internet gidget.

4.0 Information Organization of Digital Data:

To understand how the information creation process and the corresponding information retrieval process functions in QAISR architecture, it is important to understand how the information creation subsystem views the data it operates on. One of the characteristics of information as opposed to raw data is that it is amenable for a classification that categorizes different elements of information to belong to a particular class based on certain attributes of the information.

There are several possible ways to group data using a collection of files and the notation used to name the files. One is to have a collection of any files that are bound by some theme together into a meaningful group. A typical way one achieves this is through the directory hierarchy in file systems.

e.g test.c, test.exe, sample.data, menu.properties all belong to the set of files that belong to a software application test. A common approach employed to identify and locate this data is by placing them in some directory such as test.

/src/test/test.c

/src/test/test. exe

/src/test/sample.data

/src/test/menu.properties

In the above approach any set of files contained in the directory /src/test belong to the application test. This type of data organization helps locate the files based on the semantic association made with the directory naming and the location of files. It also facilitates grouping any files with any filenames into meaningful collections of information. The limitation of this approach is that if the above set of files were placed in different directories, it is not possible to interpret their association. Also, you can mechanistically validate the association between these files if the only input was the files. It does make it possible to group any random files and associate a unique location identifier in the name of a directory.

A second approach to grouping data in files is that in which the filenames encode some meaningful information about a file or a group of files. For instance all html files are by convention expected to have filenames of the form filename.htm or filename.html. The same concept can be extended to define conventions that associate semantic significance to the name of the file. You could conceivably have filenames of the type filename.extension1.extension2.extension3.extension4 . . . where each extension could have a separate semantic association that characterizes all the files that share that extension.

Let us take the simple case of filename.txt.prd, filename.txt.que are two files that have two extensions. The filename portion connotes that the two files have some semantic affinity of a kind. The first extension txt can be construed to indicate that these are text files and the second extensions que and prd indicate some thing additional about the two text files, in this case files containing some question and some product lists correspondingly. This technique however restricts the ability to have different filenames and share a semantic association. This approach allows one to discern some structure from the naming of the files itself. It is also possible to have a mechanistic way to validate if the affinity connoted in the naming is borne out by the contents of these files. It will also be possible to construct the list of files that are necessary to access all the information contained in this collection by using the filename and the semantic affinity that binds files with these extensions.

Filename.txt.prd, filename.txt.que semantics can be defined equivalently in a single file with different syntax and a single extension. This will require people invent a new extension and not benefit from existing structure that is commonly used. As install bases and new conventions are not adapted instantaneously, a way to extend semantic structure using known file extensions is essential most times.

In the above convention, the grouping of different files and the associated structure belonging to a group can be defined by a configuration file of some kind that enumerates the list of extensions bound by the semantic grouping. This file by decree can be said to have the extension cfg.

A third approach is used when several files that share the similar extensions have to be grouped together as in the first scenario, but also need a way to use the association among these files to do some useful work beyond what can be done by knowing that they reside in the same directory. This would be typically encountered in software source code organization, where all the files in a directory belong to the application, but a more structured semantics define how these files are used to develop and build software. Typically this structure is defined by a structure defining file, such as a makefile or a project file. While this provides a comprehensive way to group information, it comes with incumbent complexity of interpreting the syntax defined for the configuration file that is avoided unless it is essential that one has to process files several files with different filenames and same extensions are to be used for performing useful work.

With the advent of XML, the contents of any file can define the nature of the data stored in the files. For our discussion the type of data inside an XML file maps to file_type abstraction defined below.

All of the above approaches are used in data organization depending on the design interests, and the constraints places by the adopted standards in various usages of these data organization methods.

The approach used for QAISR based information processing is the second approach described above. This is to simplify the abstraction of data organization for the purposes of binding information to appropriate questions without the complexity of the third approach, while continuing to build on existing standards and conventions.

4.1 Metadata Semantics:

For the need of QAISR architecture to process the information to create the meta data that is QAISR specific, it is necessary to partition the information based on certain well known attributes of information. In this section we will describe the attributes of information that are significant for QAISR, and formalize the data model that is central to the QAISR architecture. The following attributes of information are central to understanding how the information creation process works. These attributes of information are: 1. file_type, 2. file_extension, 2.1 file_primary_extension, 2.2 file_secondary_extension, 3 Contenttype, 4. location_type, 5. location and 6. location_access_method. It is assumed that the information that is processed for information creation step is one or more digital data files. We will now define what each of these attributes mean.

4.1.1 File_Type:

The reader is cautioned to distinguish the colloquial definition of file_type with the definition of file_type as viewed by the QAISR architecture. File_type is the equivalent type that defines the data of the files of the same kind and use different file extensions. By conventions files with extensions html, html define files of the same type. QAISR internally keeps a list of file_types it can process at any given time. This support is intended to be extensible to new file_types.

In the QAISR architecture all data files are assumed to belong to a file_type. The file_type of a data file signifies the character encoding and the name that defines the same type of information even when different file extensions are commonly used to store the files.

File_type defined as the character encoding of the contents of the file defines the type of file, in other words the type of information contained in a file i.e. text, binary, Unicode data etc. It also maps multiple synonymous file extensions to the type of information that uniquely identifies the information to the QAISR processing modules.

file_type is distinct from file_*_extension, as in file_type can be unicode html but file_*_extension can be htm, html or any such. Traditionally, file_type and file extension have been used interchangeably. Knowing which file_*_extension belongs which file_type allows for extending the QAISR solution to multiple file_extensions without modifying the QAISR software. File_name which encodes the extensions is used by QAISR to discern the extension values (.txt etc) from the name and from that the file_type=text and this in turn is used by the information creation methods used to extract and create the question,location meta data. A dictionary that maps popular file*extensions to file_types is used by the QAISR tools. The users can modify this text dictionary to add support to new file_*_extensions that correspond to the supported file_types.

4.1.1.1 File_Extension:

file_extension is the extension of a filename followed by a period.

If filename=x.y such that “.” Does not belong to the set of characters X & Y where x belongs X and y belongs to Y.

The above definition defines files of the type abc.txt, def.html etc.

In QAISR architecture all files that are understood by QAISR programs have files of only the following types.

Filename=x.y or m.n.o, i.e there can be one or two ”.”s in a single file name. Let us call this the QAISR file naming constraint.

File_extensions are used to organize data in files that correspond to file_type/content_ype. By convention file_*_extensions provide some information regarding the type of information that is stored in the data files.

For QAISR based computing, we extend the file_extension to suit our specific needs. As will be explained in the next section it is possible for several files together to form a kind of information (for instance information of the kind software application can have several files *.class *.properties), we need a mechanism to identify the grouping of this set of files. We do this by using primary and secondary extensions.

4.1.1.2 File_Primary_Extension:

file_primary_extension is the traditional extension associated with files to signify some attribute of the information contained in the file. Instead of using file_extension, we use file_primary_extension in QAISR nomenclature as we could have a file with its primary extension to be .txt or .doc, say info.txt. This primary extension uniquely identifies the file_type of the information.

4.1.1.3 File_Secondary_Extensions:

In the QAISR scheme of things it is possible for several files with the same primary extension with different secondary extensions to form a group of files that correspond to a particular content type. As in info.txt can have several files with secondary extensions such as info.txt.prd, info.txt.loc, info.txt.que. The secondary extensions define additional attributes of the information contained in the files that share the same file name and the primary file extension and hence the file_type. This secondary extension is significant when multiple files together form information of a particular kind. (The same concept can be further extended to group collections of files with an information hierarchy.)

4.1.2 Content_Type:

At the outset it should be pointed out that content_type=file_type if only one file defines the attributes of information necessary for QAISR information creation processing.

In situations where it is meaningful to use multiple files to define a type of information, then file_type alone is inadequate to scan the information contained in these files to create the meta data used by QAISR modules.

It is assumed that all digital information is stored in data files, and these files can have various file_types. Content_type is the variable that describes the nature of the information comprising several files of various types. To elaborate, a file or files of a file_type can contain information about products, technologies or anything at all. The files, or groups of files belonging to a content type have a unique defining characteristic. We can envision a group of files defining the inventory of a company. This organization of multiple files representing a particular type of information is accomplished using primary and secondary extensions defined above.

A content type represented with single file:

Based on content_type, the questions that can be automatically gleaned and created can vary. For instance, a generic content type can help the information creation sub system (info_create.exe) by indicating to the subsystem to extract questions from a file_type say text and file_primary_extension txt, and that the text is generic text with no specific characteristics that define the kind of information contained in this text.

Content_type=text

File type=text

File_primary_extension=txt

The above attributes will define the nature of information of various files with file names such as testl.txt, test2.txt.

A content type represented with multiple files:

However two files of file_type=text can also be structured in such a way that the first file contains a set of questions and the second file contains a set of products, and info_create.exe (the application that creates the meta data from raw information) can take as input these two files and generate the meta data used in retrieving the product specific information. It is in such scenarios that the content_type defines additional attributes about the data contained in files of any given type. We use a primary extension and several secondary extensions to group several files to belong to a particular content type.

Note: All files in a conten_type need not be of the same file_type. (the primary extension defines the file_types, and additional attributes are defined by the secondary extensions)

Content_type=textproduct

File_*_extensions=txt.que and txt.prd,

Where the file_primary_extensions are txt and hence of the file_type=text

File_secondary extensions=que, prd

e.g.

Textile.txt.que contains question stubs

Textile.txt.prd contains list of products and the location where product information is maintained.

For each content_type that is supported in QAISR a precise association is made with all the necessary extensions to define information pertaining to a particular content_type.

There is a one to one correspondence between conent_type and the complete list of File_*_extensions that define a content type.

4.1.3 Location Type:

Location type defines the type of location that is being extracted by the info_create.exe application. Location_type also characterizes how the information is displayed for the retriever of the information. Some examples of location types are named_text_location, named_html_location, line_numbered_text_location, etc. . . . The semantics associated with a location_type are defined by QAISR.

The naming in the above examples encodes some file_type information information. (Conceptually location_type could just indicate whether is line_numbered, named, timed, 2d-coordinates, program_arguments etc).

Depending on the location_type information, the location values that point to a particular location in the digital data change.

In named location_type, the location=position1 is a valid value.

In line_numbered location_type, the location=23 is a valid value.

The location type is one of the attribute used by the retriever of the information to compose the information based on the question asked, what will be displayed to the retriever of the information.

For each content_type and file_type, all the valid location_types are defined at any given time in the QAISR supported file_types/content_types, location_type dictionary. It is possible to define a new location_type semantics for given file_types and content_types.

The composition of the response is accomplished by binding a location_access_method to a value that is interpreted by the information retrieval module to present the information at the corresponding location. The location_access_method value is composed using the various attribute values such as location_type, content_type, file_type, file_*_extensions.

e.g.

The location_access_method can be a URL for

location_type=named_html_location,

file_type=html,

file_primary_extension—htm,

content_type=file_type=generic

And location_access_method can be the description of the hostname, directory, file name information for

location_type named_text_location,

file_type=text,

file_primary_extension=txt,

content_type=text.

And location_access_method can be the description of the hostname, file name of the application and the list of arguments to be passed to the application for

location_type=software_application_location,

file_type=application,

file_primary_extension=exe,

content_type=application.

And location_access_method can be the description of the hostname, file name of the audio file and the time from the beginning of the audio file for

location_type=time_location,

file_type=audio,

file_primary_extension=au,

content_type=audio.

The location_access_method indicates how the information can be obtained, and this will vary based on the content_type, file_type, location_type values.

For each content_type or file_type and a location_type a unique location_access_method syntax is defined.

This ability to bind different location_access_method values for different location_types gives enormous power to deal with various types of information such as software, audio, video etc. For each location_type, the info_create programs can create the location_access_method to be saved by the QB, or have the QB determine this value with the rest of the information stored in the QB for a specific question. Currently adding support to new location_access_methods is not specified to be pluggable. In due course, this will change.

4.1.4 Location_Access_Method:

Location_access_method describes to the information retrieval subsystem, how the information can be accessed as a response to the user question. The location_access_method is the access method that is peculiar to a particular (content_type/file_type, location_type) for the group of files that together contain information belonging to a particular content_type/file_type. The location access_method can be explicitly assigned a textual description of how the information corresponding to a question can be retrieved or by creating this information from the contents of the information corresponding to the question that is stored in the QB. The location_access_method value in the QB could be updated at the time of question insertion in the QB. However, if the access_method syntax is changed during the life of the solution, then we have a way of creating the location_access_method when the information retriever tries to compose the presentation for the viewer of the information and update the value of the location_access_method with the new location_access_method. As described later, to make QAISR truly extensible, we will need to define a generic interface (such as a Java interface) that composes a location_access_method for a given type of content_type and location_type.

5.0 Canonical Meta Data Format:

Typically the information creation subsystem through user interaction or without the users interaction, processes a collection of files to create the meta data that becomes the input to the information management subsystem. The collection of files processed for the creation of the meta data belong to a particular content type, a set of file_types and a specific location type. Using these files, the information creation program generates canonical meta data that can be passed on to the information management subsystem. The canonical meta data is contained for each collection of information generates two files with extensions some_name.hext & some_name.qext for a information collection of content type_text, file_type=text, file_primary_extension=txt and location_type=named_text_location with file name some_name.txt. These files contain the {q,l,a} information for the collection of information processed. The some_name.qext contains the {question,location, date_question_extracted} elements for each question extracted. The some_name.hext file contains information that is common to all the questions, such as email address of the owner of the information, the publication locations (hostname, directory, web-site etc.).

5.1 The Syntax of the .qext and .hext Files:

The header/question meta data files is described in this subsection.

The header file contains name value pairs of the form,

Name=value.

The incomplete specification of the valid names in a header file are,

File_type=

File_name=

Pub_base_path=

Owners_email_address=

Geographical_location=

A question file contains just the information that corresponds to all the questions in a data file.

The question file contains name value pairs of the form,

Name=value.

The incomplete specification of the valid names in a question file are,

question=

location_type=

location=

time_value=

A question file contains the above set of name value pairs for each question that corresponds to some information in the data file.

The information creation effort is partitioned into two steps. The first step is where editors, or some agent like programs take as input one or more files belonging to a particular content_type and generate files that contain meta data output in the form of *.hext, *.qext files. In fact this step is farther sub divided into the atomic act of processing a group of files to create the meta data files. And an iterating step that spans a disk to process data files of various content types. Second step is to gather all the meta data output created for each element of a given content_type. This process will ensure that incremental meta data is collected by gathering only those meta data files since the last gathering of meta data happened. These meta data files are then packaged to be delivered to the information management subsystem.

Duplicate extraction of questions maybe eliminated when same files are processed again and again. This can be achieved by keeping all uniquely extracted questions in *.qext.save and a new question is added to *.qext only if the same questions is not present in *.qext.save.

From the above discussion, it should be apparent to the reader that the info_create program can be enhanced for every new supported value of {content_type, file_*_extensions, location_type} as both info_create.exe and info_retrieve.exe will need to be modified to create and interpret the location_access_method that is unique to the {content_type, file_*_extensions, location_type} value. This can be made dynamically extensible (in other words pluggable) so that whenever a new location_type is created, a shared library or a class library that implements a QAISR specified interface (as in Java interfaces) to be invoked by these programs.

6.0 The Question Base [QB] Architecture:

The question base architecture defines the layout of a question base. It subsequently defines interfaces that can be used by the QAISR programs to retrieve, manipulate, store and manage the Question base. As described in the earlier sections, a question base is a collection of [q,l,a] triplets. We will specify in detail the composition of [q,l,a] elements. As to how these [q,l,a] elements are grouped to form the QB is left as an implementation choice.

In our implementation, we have made provision to implement the QB both as a table in a database or a flat file. Let us call the [q,l,a] triplet a question base element or qbe.

typedef struct {

question q;
location l;
attribut_list a;

} qbe;
typedef struct {

char* question_string;
int question_id;

} question;
typedef struct {

char* location_type;
char location;

} location;
Attribute list is a list of
typedef struct {

char* attribute_name;
char* attribute_value;

} attribute;

Not all the possible attributes are specified. Provision should be made in any implementation to make it possible for extending this list (with support for versioning).

The interfaces used for manipulating the question base are as follows:

The interfaces are specified as base abstract classes. Each pure virtual function and its arguments are specified. QB's can be implemented using various storage facilities on a system, be it a flat file or a database. The implementers of the interface for a particular storage type need to derive from the base class.

To locate the answers in the QB for a given question

class LocateAnswers {

virtual void GetDataRecordsForQuestion(CString question, CData_Record_List cdrl)=0;

}

description of the data structures:

Cdata_Record (consider renaming this to qbe) is the class that implements the qbe defined above. It has the fields for the data and the GetData/SetData methods to retrieve and store these values in this structure

virtual void GetDataRecordsForQuestion(CString question, CData_Record_List cdrl)=0;

The above interface takes as input question and extracts all the qbe elements in the QB that have a matching question and returns the list of these qbe elements in the cdrl structure. To store the qbe data into the QB:

class QuestionStorer

{

virtual int StoreNewQuestionLocation(CString question, Cstring location_value)=0;

virtual int GetQuestionLocationIDfromQuestionAndLocationlnfo(CString question, CString question_field_name, CString location, CString location_field_name)=0;

virtual BOOL StoreNameAndValueByQLID(CString name, CString value, int qlid)=0;

virtual BOOL StoreNameAndValuePairListByQLID(NameValuePairList nvpl, int qlid)=0;

};

Datastructures used in the arguments of the interfaces are:

NameValuePairList is list of name value pairs that are used to store the information to the QB storage (database, file etc.)

An example of a namevaluepair would be {Name=question, Value=Who am I?} Interface semantics

virtual int StoreNewQuestionLocation(CString question, CString location_value)

This interface takes a question and a string formed by concatenating the two elements of the location element in the qbe arguments to be stored as qbe data in the QB storage. The name and value is bound a unique qlid or question_location id that is used for manipulating this qbe element for any subsequent updates or modifications. The qlid is returned as the argument. There is a one to one correspondence between qlid and {question_string, location element}

virtual int GetLocationIDfromQuestionAndLocationInfo(CString question, CString question_field_name, CString location, CString_location_field name)

This is a helper interface that helps in retrieving the unique qlid using the question string and a location string.

virtual BOOL StoreNameAndValueByQLID(CString name, CString value, int qlid)

This interface lets you store a single name & value pair using the qlid value obtained from the first or the second interface. Returns true if the operation succeeds.

virtual BOOL StoreNameAndValuePairListByQLID(NameValuePairList nvpl, int qlid)=0;

This interface lets you store a name, value pair list using the qlid value obtained from the first or the second interface. Returns true if the operation succeeds.

7.0 The Architecture of Information Creation and Storage:

The word information is used in a very loose sense encompassing information in text, pictorial, audio, and various other forms. Information creation can be of two types: 1) creating meta data necessary for the information to be useful for QAISR architecture using existing information, and 2) creating the information and the associated meta data for the first time. In the second type of info creation, the application(s) used for the creation of the information expect user input of some kind. Similarly, info creation using existing data could also need user input. However, the user input is not necessary for extracting question meta data from all existing data as we can extract meaningful questions from data files that already contain questions (such as faqs). The following sections describe a set of applications that make it possible to create information using user input and another set of applications that process the data without any user information.

7.1 Info Creation With User Input:

In this section we will describe the kind of applications that will help in creating information that is tailored to be processed for QAISR architecture.

It is assumed that all information will be created or modified using some kind of an information editor that is specific to a file_type(content_type) (for example Microsoft Word for text, a bitmap editor for images etc.) In this architecture specification, we will discuss about making such editors create the meta data needed by the QAISR architecture. There are two approaches to designing the applications that will help in info creation using user input. One approach is to create an object/component (activeX/java bean et al) to make it possible for the editors of information to use the functionality of creating the meta data as part of their application environment. The other approach is to provide existing editors with the type of functionality that will help in generating the meta data needed by the QAISR architecture. An editor vendor can acquire the bean/activeX component and easily integrate the meta data creation functionality with their currently selling editors. The bean/activeX object takes as input the data necessary for meta data creation: questions, location info, {q,l,a} attributes and allows the user to save this both in the *.qext, *.hext meta data files as well as inserting this data in a canonical form within the files being edited. (meta data can be inserted within the information, including in html, text files besides the traditional metadata files.)

However it is not practical to expect all information creation vendors to integrate the bean into their editors as soon as the meta/data component is ready for integration. In order to simplify the user experience, we also created a meta data generation helper application that can be launched simultaneously with the editor that user uses to edit the information of users interest. The user in this scenario interacts with a different window frame when editing the information and the meta data. The integration of the user workflow is less than desirable when using the meta data generation helper application. (The name of the application in our implementation is legacy UI).

We will briefly describe two interesting topics of information creation, canonical question data stored within the information file, and the question transformation that can generate more questions than typed by the information creator.

7.1.1 Information Creation of Raw Text With User Input:

In this section we will describe a simple heuristic an information creator may use to questionize the text information created by them. This simple heuristic is presented to illustrate how information creators can systematically create the question data for plain text that is either newly being created or something that already exists.

a. Read a Paragraph

b. Identify the possible questions that are answered by the information in the paragraph.

c. For each question:

a. Exhaustively write down the alternative ways in which the question may be asked (You can actually ask Qme to find out what are some typical questions people are asking on the key subjects addressed in the paragraph)

b. Change tenses

c. Change number

d. Consider synonyms

e. Consider various pronouns (preferably first person)

f. Always include questions such as Where can I find xyz?

d. Include all the questions in the text using the syntax that will enable the tools to glean the metadata

e. For each sub-section that contains several paragraphs go over steps a . . . d and then go through the same steps as though the sub-section is a single paragraph.

f. Use step e to exhaust all various forms of collections of text that contains elements, such as paragraphs in sub-sections, sub-sections in sections, sections in a document etc.

7.2 Syntax of Canonical Meta Data Format in HTML/Text Files:

As mentioned earlier it is some times useful to insert question meta data inside the files containing the information itself besides the *.qext files. This helps in people manually inserting this data without the help of the info creation tools, and have the data automatically be gathered by non-interactive information creation tools. Also, the encapsulation of question meta data with the actual information that corresponds to the questions helps in the readability of the data represented by the information without any fancy software tools.

The syntax of inserting these questions can be different for various file_types and content_types. We will specify the syntax that is used for all text and text like files such as html.

<QUESTION Where can I shop for a vegan shoe? #LOCATION location1/LOCATION# /QUESTION>

<A NAME=locationl></A>

7.3 Question Transformation:

One of the ways in which more questions can be generated from existing question in meta data is to use natural language processing [BRIL95] to create several similar meaning questions from a given question.

For example,

What can I buy today from Subway?

Can be transformed into

What can be bought by me from Subway?

Through the rules of English language grammar.

All the meta data created can be used to generate additional meta data to increase the possibility of matching the user questions with the information that is available.

The info creation process can be described using the following pseudo code

file_name=FileSelectionGUI( )// to select the data file containing the information

file_type=find_file_type(file_name);

editor=find_editor(file_type);

status=DidImplement_meta_data_generator_object(editor)

if (status=true)

Invoke(editor(file_name));

else

Invoke (editor(file_name), meta_data_generation_helper);

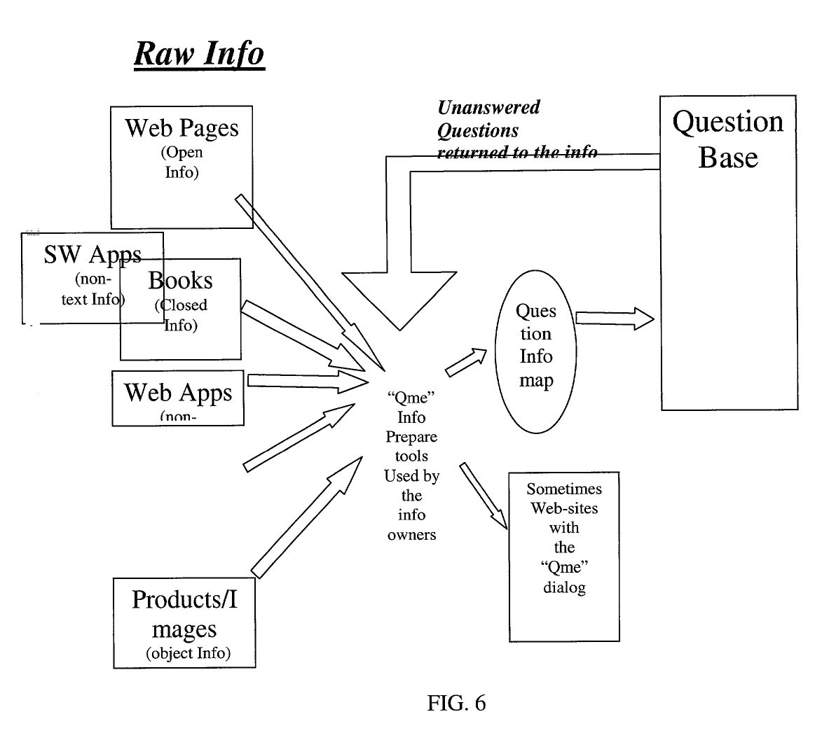

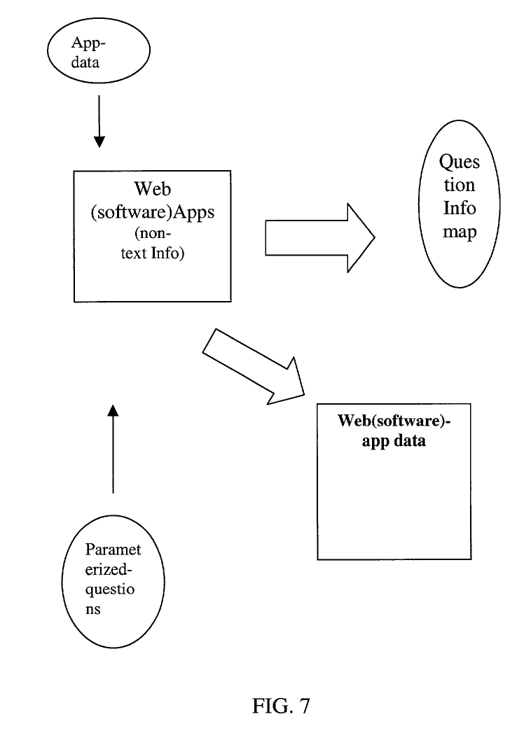

Information creation tools themselves include the questionization functionality that are tailored for individual applications. This is better explained in the parameterized information creation. Refer to FIGS. 6 and 7.

7.4 Info Creation Without User Input:

The two factors that make an application that processes information contained in files without user intervention are:

1. an automated way to extract the questions, and corresponding locations from files if the meta data is embedded within the files,

2. to process data that is structured to minimize the effort involved in binding questions to locations of closed and open information.

In the first scenario, it is feasible to write software that processes files of the file_type=text, html, . . . and extract questions that have been previously inserted by the authors of information. Typically this type of data can be extracted from FAQs, news groups, forums etc.

Also, this approach can be used to extract question meta data that has been inserted in the information files themselves.

In the second scenario, some specialized content_types can be created to automatically generate large number of questions rapidly. If for instance, a vendor has several URLs as repositories of information and similar questions can be asked about these products, then defining a new content_type for this type of information provider can improve the productivity of creating questions. It is conceivable to create a question stub file, and another file with name value pairs of product=URL, then the meta data creation can be automated.

The application that processed both the above scenarios is called info_create.exe.

It can be invoked as

Info_create.exe filename

Or

Info_create. exe filename configfile

In the first invocation, info_create tries to extract file_type(and hence conten_type as there is only one file) from the filename generates or updates the meta data files filename.hext, filename.qext.

In the second invocation, the configfile contains information such as content_type, valid file_*extensions and such that help in creating the meta data. The syntax of the configfile defines name value pairs that are different for different content_types. Anytime support for new content_type is added, the structure of the configfile needs to be specified completely, and the info_create.exe has to implement the methods that allow meta data extraction for the new content type.

7.5 Information Creation From User Databases Without User Input:

In this section we describe how information creators can take advantage of QAISR architecture, when the information that they manage is stored in a database.

7.5.1 The Problem:

In today's usage of internet, not all information that user's are interested in is actually stored in the form of text that is searchable. A good amount of information is stored in structured databases that are made visible to the world over the internet in order for people to benefit from the information. Businesses are built around the value of this information to users. Since this information is stored inside the databases, they do not lend themselves to be easily found by users that do not already know how to find the particular database.

7.5.2 The Reason the Problem Exists:

If a user does not already know of a web-site that has the database that she can use, the user would be best served if there is a generic way to locate the database. Some directory services/portals enlist database driven sites that a user may try and find, but when even the number of portals is large and the portal managers cannot keep up with the volume of the number of databases that are being exposed to the internet, the chances of there being a database that is useful to the user and not being found is significant. In the case of generic text the user right now can go to a search engine of some kind that does not use QAISR technology that does not bind to questions and still chance upon a document that is of relevance to the user. The same cannot be said for the databases even at a very high-level.

For example, a user cannot go to a particular web-location and find where the internet vendors of research articles/music CDs can be accessed. It is even more difficult for some one to locate where a user can buy a particular research article/music CD whose availability status is stored in the database.

Search technologies that crawl web-sites do not have a generic way to explore the database to make it possible for users to stumble into the item that they are looking for. In other words, a user is unlikely to find the vendor of a particular research article/music CD by just going to a search engine and entering the title as text even if there is a web-site whose database contains this information. The QAISR architecture makes it possible for a vendor of the article/music CD to increase the probability of the user to find this information.

7.5.3 How QAISR Based Info Creation Helps Solve the Problem:

Using QAISR as described in this section will help solve the problem described above. QAISR can help in two different phases, the information creation phase and the information retrieval phase. Both these phases involve some work in the information creation phase and we will describe the effort involved and then describe how on doing this the user is able to address the problem.

In the information creation phase, the creator can do just one or both of the things described below.

7.5.3.1 Create Wildcard Metadata for Parameterized Information Retrieval

This particular task of information creators that helps in users finding the information that they are looking for requires some understanding how the information retrieval phase works. In this section we will briefly describe what happens during the information retrieval stage and a note of the effect of this technique on information retrieval functionality is made in the information retrieval section.

The primary advantage to the information creator by using this technique is for enabling users to have their first leading question, when they are in quest of some information, lead them to the web-site database that then can be used for transacting with web-site.

Let us say that the information creator is a music CD vendor, and the vendor realizes that the information retrievers tend to pose the questions of the form:

Where can I buy Beatles CDs?

Where can I buy Rolling Stone CDs?

Where can I buy REM CDs?

Any music vendor may answer questions of the above form. Thus the music vendor creates what is called a parameterized question of the form:

Where can I buy ARG1 CDs?

Or using regular expression wild cards

Where can I buy * CDs?

And let us say the music vendor web-site is located at www.acmemusicvendor.com

Using the QAISR meta-data syntax, the vendor creates the meta-data using a wild card in the field where the band name is in the generic question. Just by doing this, the vendor can expect the user to find their location whenever a user asks the above question. The information retrieval subsystem for every question entered in the question field generates a permutation of wild card substitution for a given question and tries to match them in the QB.

That is if a user enters the following question in the question field,

Where can I buy Pearl Jam CDs?

The information retrieval subsystem generates the following wild-carded questions on the fly:

Where *?

Where can *?

Where can I*?

Where can I buy *? . .

*can I buy Pearl Jam CDs?

*buy Pearl Jam CDs? . .

Where * can I buy Pearl Jam CDs?

Where * I buy Pearl Jam CDs?

All these questions are then used to find matches in the QB.

This technique while it ensures that an information creator that answers the specific question and has used QAISR architecture will certainly be discovered by the information retriever, there will be several music vendors that will be detected by the information retriever even when the particular vendor may not carry the specific band. The next technique provides a better way for information retriever discover only those that carry CDs of a specific band.

This is a distinct benefit of QAISR technology that the information creators (music vendors) and the information users (music CD buyers) could not benefit from.

7.5.3.2 Parameterized Generation of Questions for Database Elements

Let us suppose that the same kind of a music vendor discussed in the previous section is using this technique. Unlike the previous vendor, this music vendor uses a software application called the DBquestionizer that is created by either QAISR team or the music vendor based on the economics involved. The Dbquestionizer application created takes as input two data sources, the web-site database that contains all the music CDs sold at this vendors site and a parameterized question list.

Let us say that the database of the music vendor has the following table of music CD data:

| | | | | |
|---|---|---|---|---|
| Band Name | Album Name | Price | Other vendors | Vendor Web-site |

Dire Straits
Jethrotull
Nirvana

Either QAISR team or the music vendor knowing that the users may ask the question of the form

Where can I buy * CDs?

Where may I buy * CDs?

What is a good place to buy * CDs?

creates a parameterized question list of the form

Where can I buy $ARG1$ CDs?

Where may I buy $ARG1$ CDs?

What is a good place to buy $ARG1 $ CDs?

The questionizer takes as input the parameterized question list and the database as inputs and generates the meta data of the form:

Where can I buy Dire Straits CDs?, [location of vendor web-site]

Where may I buy Dire Straits CDs?, [location of vendor web-site]

What is a good place to buy Dire Straits CDs?, [location of vendor web-site]

Where can I buy Jethrotull CDs?, [location of vendor web-site]

Where may I buy Jethrotull CDs?, [location of vendor web-site]

What is a good place to buy Jethrotull CDs?, [location of vendor web-site]

Where can I buy Nirvana CDs?, [location of vendor web-site]

Where may I buy Nirvana CDs?, [location of vendor web-site]

What is a good place to buy Nirvana CDs?, [location of vendor web-site]

When this meta data is uploaded into the web-site, the questioners will be able to precisely locate the vendor that sells a specific album. This is another attribute that makes it attractive to those that would like their location of information to be discovered by any one that could benefit from discovering their location.

7.5.4 The Case of Questionizing Data in XML and Annotated Fields of Documents:

The method described above states that it applies to questionizing database records to help improve the findability of these database records. The same method is extended when structured data is encapsulated in documents using some of the contemporary tagged text technologies such as XML/html etc. In this case, the text will annotate the name of the musician with a tag of some kind such as <MUSICIAN></MUSICIAN>, <ALBUMNAME></ALBUMNAME>. A dictionary of the kind ARG1=<MUSICIAN></MUSICIAN>, ARG2=<ALBUMNAME></ALBUMNAME>is also used in QAISR architecture in conjunction with the parameterized question list to generate the questions from a document. Every document creator in effect has to find the suitable parameterized question lists and their associated dictionaries and input them along with the documents to generate as large a number of questions as possible.

7.6 Information Creation for Closed Data:

7.6.1 The Problem

One of the classic difficulties that traditional information retrieval solutions face is how a publishers of information can enable the retrievers of information to locate where the information is even when the creator of information does not intend to publish the information for easy access. For instance how does a e-book vendor that wants to sell a particular e-book and would like people to discover her web site where a customer can do the purchasing transaction to obtain the e-book in a secure manner. In particular the person that would purchase the e-book is actually trying to find some information, and is not even aware of the fact that the e-book contains the information he is looking for.

7.6.2 The Reason the Problem Exists

In order for a customer to discover the e-book vendor, the customer is expected to use one or both of the following two technologies. The customer may chose to use a search engine that crawls the web to categorize all the textual information into broad categories as some web portals do. Or the customer may chose to use a search engine that catalogs the open textual information to create a searchable index that tries to correlate user entered key words to some document that may be of interest to the customer. In both scenarios, the search engines will not be able to use the text contained in the book to help the users trying to locate information contained in the e-book as the vendor of e-book does not want to publish the content but is still interested in customers finding the e-book if the information that they are looking for is contained in the book.

7.6.3 How QAISR Based Info Creation Helps Solve the Problem:

In this particular scenario using QAISR tools to create question bindings to various portions of e-book, and using the vendor location as the location in the [q,l,a] triplet will enable the e-book vendor to propagate the plausible questions into the QB without actually publishing the e-book. This step will facilitate in leading enquiring customers to the e-book vendor site even when the e-book vendor has not submitted the content of the text to search engines to help them lead customers to the e-book vendor site.

This particular aspect of QAISR will help numerous information creators that do not like the information that they possess to be freely available. Organizations such as market/consumer research firms that sell reports, digital libraries are a couple of examples.

7.7 Information Creation for Audio/Video Data

7.7.1 The Problem

As with closed information, the traditional search engines, which are the general purpose starting points for people that are trying to find information, cannot help the information seeker that is seeking audio/video or any other non-textual information.

7.7.2 The Reason the Problem Exists

The most general purpose information locators, the search engines, do not process non-textual information to help lead the user to the non-textual information that the user is attempting to find.

7.7.3 How QAISR Based Info Creation Helps Solve the Problem

The information creation tools of the non-textual information are not precluded to bind questions to the entire information content, or the specific locations in the information content. This will enable the information creators to help the information seekers find the information that they are seeking when the information is of non-textual nature. Considering the information seekers use the same technique to locate textual and non-textual information, this QAISR based approach becomes a more general purpose technique of information seekers.

7.8 Information Creation for Software Applications

7.8.1 The Problem

Several software applications store information in structured manner that the users of these software applications save and store. This information could be the addresses of contacts if the application is an address book, bills to be paid if the application is a financial application. It is not uncommon for people to use multiple applications of the same type such as address book applications as these tends to bundled with other applications such as e-mail tools, collaboration tools. It is also not uncommon for people to store the data generated by these applications in different locations. When a user is interested in finding a specific address, in the current scenario the user has to try all the permutations of locations where address books may be stored and all the different applications that may have been used in storing addresses. This makes it difficult for the user to locate the information that the user is trying to find. The user would just like an answer to the question “What is the address of Carmen SanDiego?”. This problem compounds in an enterprise scenario where numerous people use numerous applications and numerous locations to store the information and are willing to share the information if some one other than them is interested in finding the information.

7.8.2 The Reason the Problem Exists

The reason the problem exists is due to the fact that applications are developed in isolation, and until now there is no simple way for applications to help the user find the information that the user may have forgotten where the user has stored using their application. Techniques such as search engines tend to be inadequate in helping with software application created data as this data is not typically stored in textual documents.

7.8.3 How QAISR Based Info Creation Helps Solve the Problem

Once the QB meta data syntax is standardized and available for use, application developers can generate question meta data to be propagated to a QB much like how meta data is generated in parameterized generation of questions for database elements.

In the address book example, an application may keep the parameterized question list such as:

Where can I find the e-mail address of $ARG1$?

What is the e-mail address of $ARG1$?

Etc.

Considering the address book application internally has access to this information when a user first creates an entry for a contact in the address book as variables of an application, and since the application knows the location where the information is being stored, the application can then generate the [q,l,a] entries for the contact information. Once this data is generated, the process of propagating this data to the QB is not any different from propagating this data for any other kind of data. After this step, a forgetful user can always use QAISR based approach to find the application and the data for a contact as and when he needs it.

7.9 Information Creation for Finding Software Applications

7.9.1 The Problem

In order for people to benefit from creating more findable data, people can minimize their effort if they used the applications/tools that are described in section 7.8. However, people need to find the applications that will help them use the applications/tools that can be used to create the data of interest to the people with such need. For example, if some one wants to save their address, they can use an application that helps one save address data such that the data is findable. However, the user needs to find the application that lets them do just that.

7.9.2 The Reason the Problem Exists

This problem exists because, the information regarding the capabilities of applications itself is not questionized.

7.9.3 How QAISR Based Info Creation Helps Solve the Problem

The software application developers will help the prospective users of the application by questionizing information about the application itself. By doing this, the creators of information can create questionizable data without prior knowledge about the tools/applications if the UI is built using the popularly understood UI elements and if the tools can be discovered by simply asking questions. Since people will want to create information relating to concepts that they are familiar with and have an understanding of these concepts, it is possible for people to create findable data without needing to learn all the tools that help in the creation of the information except when they need to create the information. This they can do by simply asking the question that will point them to the appropriate tool. This in effect improves the amount of information that is created which is more findable. It is this facet that makes people function usefully in information creation solely based on the knowledge they carry in their human memory.

7.10 Information Creation That Will Help People Find Physical Objects

One very useful application of QAISR architecture is enabling people find physical objects by using a simple architecture called POQAISR (Physical object question associated information storage and retrieval) that is based on some existing technologies. We will describe the architecture and the information creation for this architecture in this sub-section. The information retrieval part of the architecture is described in the information retrieval sub-section.

7.10.1 Physical Object Question Associated Information Storage and Retrieval (POQAISR) Architecture:

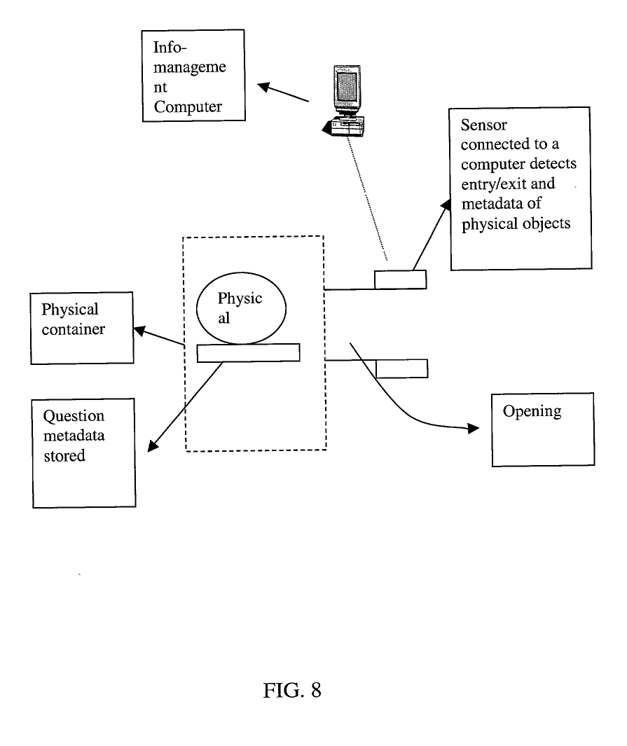

In the POQAISR architecture every physical object is said to be contained in a physical container. Some of the examples are books in a bookshelf, where the physical objects are the books and the bookshelf is the container, or a bookshelf in a room, where the physical object is the book shelf and the physical container is the book. POQAISR takes into account certain attributes of the physical objects and containers to devise the strategy that will help people find the physical objects as and when they need them. Both the physical objects and the physical containers are altered and modified to facilitate their participation in the POQAISR architecture. Refer to FIG. 8.

7.10.1.1 The Properties of Physical Objects:

Every physical object that participates in the POQAISR is a solid and physical objects in other forms are said to be contained in solid containers thus becoming physical objects. We therefore confine ourselves to solid physical objects.

It is possible to stick or attach a magnetic strip or some data storage medium that can be sensed by the sensors of the said medium.

If necessary it is possible to attach a GPS device that allows people to locate the co-ordinates of the physical object.

7.10.1.2 The Properties of Physical Containers:

Every physical container has opening(s) through which the physical object is inserted in the physical container.

7.10.1.3 The Modifications to the Physical Objects:

A magnetic strip (or some other data storage medium) is attached to the physical object, and this data storage medium stores question metadata pertaining to the object. The question meta data is created by the creators of the physical object at the time of manufacturing of the physical device.

Depending on the need to find the precise co-ordinates of the physical object, the physical object may be attached a GPS device that is associated with the physical object and is matched with the magnetic strip so that the sensors know which physical object corresponds to the GPS device.

7.10.1.4 The Modifications to the Physical Containers:

Each physical container attaches to every opening of the container, a sensor that can read the magnetic strip (or any other data storage medium) attached to the physical object.

The sensor is connected with or without wires to a computer that has the infrastructure to propagate question meta data stored in the containers. Every time a physical object is inserted into the container or removed from the container the sensor can detect removal or insertion and scan the meta data and propagate the meta data to the computer that manages the information.

7.10.1.5 Entering and Removing Objects From a Container

As we described in our previous sub-section each time an object is inserted or removed, the sensors will update the QB in such a way the meta-data reflects what is contained in the container.

Also, it should be noted that an object can enter several containers and be contained in several physical containers as a book contained in a bookshelf as well as the room containing the bookshelf. A software module in the home computer that the various sensors are connected can create a containment hierarchy and plug into the information retrieval engine to help the user find the object by showing all the containers in which it is contained.

7.10.1.6 Information Creation for the Physical Objects

In creating the question meta data pertaining to a physical object, the manufacturers of the physical object should generate the default set of questions that may lead some one trying to find an object to the object that they are trying to find. As the manufacturer produces several objects of the same kind and does not distinguish between each object, the meta data created is identical for all the physical objects created. The storage media on the physical objects is read write. With that it is possible special purpose software to process some parameterized questions that are also stored along with fully qualified questions that identify the owner of the objects in order to distinguish between objects owned by different people. The QB computer can store the name of the owner and some additional information that in conjunction with the parameterized questions lead to the fully qualified questions that then get stored on the physical object and the owner has way of re-creating these questions when ownerships change.

Similarly, the owner of the object can insert his/her questions that will help the owner identify the objects using the terms that the owner prefers to use in identifying these objects.

When this created information stored on the physical object storage is pushed into the QB computer, then it becomes possible for the some software in the QB to determine the containment order of objects within a boundary of containment such as a house or office etc.

7.10.1.6.1 Distinguishing Between Several Similar Physical Objects

When the owner has several objects of the same kind, one technique the owner could use to find the physical object is by naming the individual objects.

A GPS device will help people find the co-ordinates of every object precisely, thus helping the person trying to find the object.

7.10.1.7 Information Management by the Physical Containers

The computer to which all the sensors of the containers are connected is itself connected with the QAISR architecture to push the question meta data obtained from the objects to an appropriate QB.

7.10.1.8 Software that Figures Out the Containment Order and GPS Data to Help the User Locate the Physical Object

On the computer that is connected with the physical container sensors various software modules that help in POQAISR solution are executed. One of the module helps the owner of the physical object to enhance the question metadata on the physical object to append to the factory default meta-data. Another software module is the one that can visually render the containment of all the containers within which the physical object is contained to help the user locate the information when the user asks the questions that requests finding the physical object. Without the assistance of GPS devices attached to containers objects the software on the computer may not be able to precisely locate the objects but provide enough assistance to the user to locate the device. GPS assistance will completely help the user navigate to the precise location of where the object the user is trying to find.

7.10.1.9 Security in POQAISR

The same security concerns of others locating information that the owners of information do not wish to be found exist for physical objects. The same security techniques are used to prevent non-owners from finding out about physical objects that the owners of physical objects do not wish to be found.

7.10.2 Advantages of POQAISR

Besides the obvious advantage of people being able to locate any physical object without having to remember where they kept something, there are additional advantages of inventorying and auditing of inventories of physical objects owned by someone. In order to facilitate inventorying and auditing of inventories, a separate software module (the software module is very similar to the musicQme software agent that tracks the illegal dissemination of information) that asks the appropriate questions to identify all the objects owned by and individual and collate the visual information for the user will tremendously reduce the cost of inventorying and auditing functions at home and work. In fact audits on inventory can be performed instantaneously by locating all the physical objects at any given time using POQAISR and then manually ascertaining where the physical object is expected to be found (just in case tampering of containers and physical objects did not lead to a mistake in the taking stock of the inventory.

By keeping track of when an object is inserted in a container and when it is removed, it is possible for investigating pilferages by finding when something was kept and removed from a container.

7.11 Questionization/Questionizing and the Effective Canonicalization of Access Method of All Information to Text Based Access:

The act of binding questions to information is sometimes referred to as questionization or questionizing. The task of questionization singularly accomplishes the task of canonicalizing the access method of all information, irrespective of what kind of information is being accessed into text based access. This simple act having a text based access of all information through information creation workflow leads to the numerous advantages delivered by QAISR architecture.

7.12 DiskCrawler:

A utility application that can scan crawl disks and URLs to generate meta data for multiple files is created to automate the process. This helps in processing several files on an entire disk or the web to harvest for the meta data in one invocation. DiskCrawler invokes info_create.exe with all the supported config files on the files located on a disk.

7.13 Gatherer:

A gathering utility that picks up all the created meta data files to be packaged for them to be propagated to the QB has been constructed as well.

In effect a user can use info_create.exe, or many different editors to create the meta data files when they process the information, and have periodic scanning of the disk using diskCrawler and a subsequent invocation of gatherer to package the meta data to be pushed to the QB. The install wizard will allow the user to schedule periodic automatic updates to the QB. If the user chooses this option, then the user effort to create meta data is as simple as invoking the applications.

8.0 The Architecture of Information Management:

For a variety of reasons, there can be several QBs in any network of computers. Security, project/organization boundaries etc can be some of those reasons. It is important to specify how the data from various QBs can be consolidated, so that the retrieval engine can have access to all the information it has a legitimate access to.

A push and pull based propagation of the individual QB data to the central QB data will consolidate the QBs. A tree like hierarchy is used as depicted in FIG. 2 to interconnect the QBs in such a way that child QBs provided the QB data to the parent QB. Each individual QB will have an access control policy that will determine which QB data is to be propagated to a higher level. The default is to not propagate a question bound by the user to some information and stored in the QB. Only an explicit authorization by the owner of the QB, or the explicit modification to the policy will allow QB data to be propagated up. This is to ensure that only that information a information creator wants to be discovered is the one that will be propagated up. Refer to FIG. 2 for the pictorial depiction of the QB hierarchy.

A configuration policy syntax and semantics will govern the joining of a QB to the QB tree, and it will also govern which portions of child QB is to be propagated to the parent.

Information management module at minimum will take the *.qext and *.hext files and insert them in QB.

Please refer to the “The effectiveness of the QAISR based information retrieval engines” [SHAN00a] for discussion on how the QB can be partitioned and the information retrieval subsystem modified to improve performance and scalability of the QB in reducing the latency of retrieval.

9.0 What is an Internet-Gidget:

In this section we will first describe what an internet-gidget is. We will then go on to describe how the QAISR information retrieval module is designed as an internet-gidget.

An internet gidget is an internet service bound to a pre-built user interface client component. The client component is integrated with some user software, and the service software runs on some publicly accessible remote system like any server software in client server systems. While the internet gidget in itself provides some useful functionality, its value is greatly enhanced if the internet-gidget is easily integrated within an existing application of some kind that enhances the value of the application to the users.

As an example, you can create a spell checking software as an internet gidget. The user interface component of this software allows users to type in the text that they want to check for spelling. The user interface component is integrated into some software that the user interacts with, e.g. word processor, internet browser etc. The actual software that implements the algorithms that take text input to check for spelling mistakes is run on a remote system. Any software that integrates the spell checker internet gidget in their software interacts with the same server to process the text for spell checking.

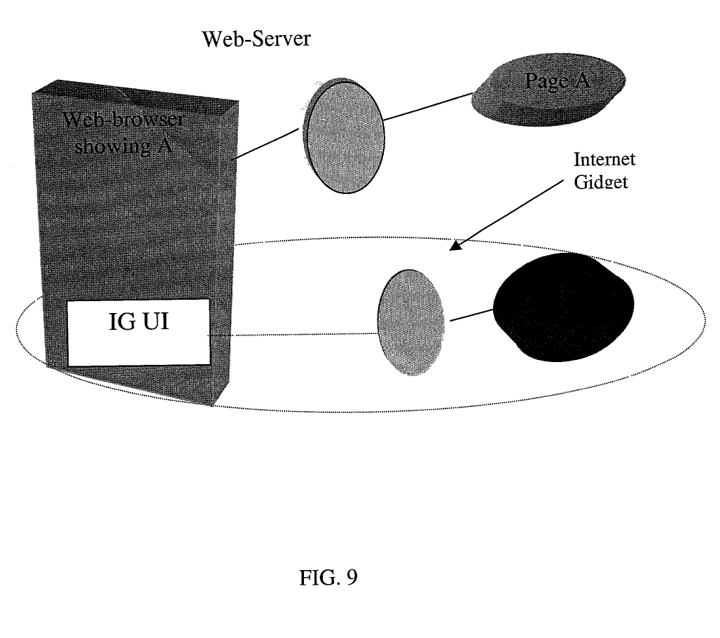

In the diagram FIG. 9, you can see the UI element integrated as part of a web page, and displayed to the user through the browser. There are significant advantages to this design.

We will enumerate the advantages here:

Internet Gidgets can be designed by the experts in a particular field.

Internet gidgets can improve over other standalone services by improving the computing on the server end tailored the particular users context. For instance, the internet-gidget UI can communicate to the server the particular web-page that is being viewed to enable the server to perform operations that are page specific. This design advantage is leveraged tremendously in the QAISR information retrieval module.

The business success of internet gidget creator is dependent on how many people embed the gidget in their portals/web-sites/web-applications, and how many people use these portals . . . .

Unlike portals that try to direct users to a web-site, gidgets try to get embedded in as many web-sites as possible.

Internet Gidgets are different from App Servers, as most App Servers too try to concentrate the traffic to a single web-site.

The dynamics of making an Internet Gidget a business success is different from that of Portals and App Servers.

In other words, in the world wide web, the content creation and the content viewing is distributed. Internet gidgets mirror that model.

9.1 How Does QAISR Benefit From Becoming an Internet-Gidget?

By making the information retrieval UI element into an internet gidget we will be able insert the UI in any web page, or any application.

This combining the web-page, with the retrieval UI will let us accomplish the following:

It will establish a context between the searcher and the information that the searcher is currently viewing when the user asks the question.

The context enables us to sort the searches according to the context, and also capture questions that are unanswered at a site to supply to the creator of information.

By design, the information retrieval will check the location (i.e the web-site) where the question is being asked and sort the retrieved responses to the question in such a way that the information corresponding to the current web-site (based on the URL, or the info-owners email address). This gives an incentive for the information creator to participate in the QAISR architecture, as her information can be accessed from any web-site that displays the internet-gidget but also helps the creator to retain attention of visitors to her site.

Similarly, the users physical location can help in prioritizing geography related questions such as:

What apartments are available for rent?

10.0 The Architecture of Information Retrieval:

10.1 The Information Retrieval Work Flow:

The information retrieval component of the architecture is a combination of programs, for obtaining a question from the user. The programs can be classified into three types of programs: UI programs (applets), transformation programs, retriever programs. The work flow of how the question is input by the user and a response supplied by the information retrieval architecture using these programs is specified in this section.

10.1.1 UI Program(s)/Applets:

One of the programs, called the UI application, provides the UI for receiving a question from the user, that is web based (it could even be a voice based interface). The UI program feeds the question retrieved from the user to several transformation programs registered with the QAISR architecture. After each transformation program completes the processing, these programs supply back a response that can be presented to the user in a presentable (displayable/listenable) format. The UI program consolidates the presentable response from the transformation programs, and presents to the user.

10.1.2 Transformation Programs:

Once the question (called the asked question, or a-question) is retrieved by the UI program, it is fed into various programs, called the transformation programs. These programs process the question to generate further questions that are called the transformed questions or t-questions. Each transformation program has a particular transformation that is very well specified. For example, a transformation program can take the a-question and come up with a similar meaning question, as in (Where is Sunnyvale?) transformed to (What is the location of Sunnyvale?). Refer to the document on the theory behind the QAISR architecture for examples of other transformation programs. This could even be a simple pass through program that takes as input a-question and outputs a t-question. The output of t-questions from the transformation program is sent to the retriever program to obtain the locations of answers corresponding to t-questions. Once the locations of answers are obtained, these answers are further processed by the transformation program to create a presentation to be used by the UI program. The natural language parser technology that is currently available in the market place can be used in constructing the transformation programs.

10.1.3 Retriever Program:

The t-questions are then input to the application (called the retriever programs) that takes as input a t-question and retrieves the locations of t-answers (for the t-questions) from the QB using the LocateAnswers interface. The {t-question, t-answers} data is supplied back to the transformation program that generated the t-questions.

The information retriever program will log the question data and those that do not have answers in the QB in order to help in creating info/answers for unanswered questions. Over time this will improve the effectiveness of the system.

The above work flow is designed as an internet gidget. And all the web pages that are processed for information creation to generate the question meta data are appended the UI portion of the information retriever implemented as an applet of HTML code. The applet retrieves the context such as which web page is viewed to order the search results that correspond to the web site being viewed, or the information that is created by the same publisher. Thus, with internet gidgets for QAISR info retrieval module, we can perform context sensitive searches.

10.1.4 Information Retrieval by Generating Parameterized Wildcard Questions:

As we discussed in the information creator section, the information retrieval subsystem has to generate plausible wild-card questions which in turn can be used to look up in the QB to find plausibly matching sources of information. In the order of presenting to the user, the wild-card question generated responses are presented after the responses from more precise techniques of information look up are presented. This technique benefits the users to locate information sources that are not text centric and store their information in databases and such.

10.2 Information Retrieval With Varying Degrees of Precision

Using QAISR architecture it is possible to retrieve information whose correlation to the question asked is varying degrees of precision. The information retriever can control what degree of precision they want their retrieval to be constrained by. The three subsections elaborate how the degree of precision varies in the retrieving of information.

10.2.1 Precise Question Match Retrieval

The precision of the information retrieved to the question asked by an information retriever is expected to be the greatest if the question asked precisely matches the question created by the information creator in binding the information to the question asked. By default the information retrieval tries to find only precise matches. Here the precision of the users expectation matching the creators response is contingent on the veracity of the creator of the information. This aspect of calibrating the veracity of the information creator is dealt with using a voting technique that is described in the section relating to security.

10.2.2 Approximate Question Match Retrieval

As we described the process of question transformation above, it is possible to compose plausibly precise matches to questions asked by the user. This will be done in two ways. One of the ways is where the transformation process attempts to find matches to the user question. The second approach is to glean the key words from the user question, and use these key words to identify those questions from the QAISR QB that may have some correlation to what the user is attempting to find. Both of these methods may not fetch the precise response that the user expects, but an approximate match to what the user is seeking may be found using this technique.

10.2.3 Retrieval Lookup of Questions Using Key Words

Finally, the user has access to the questions of the question base that they can look up using key word searches to scan the set of questions that most pertain to what the user is attempting to find. This technique is useful for those that are trying to educate themselves on a subject. They can discover all the answered questions relating to a particular subject and read the responses to the questions that to them seem interesting.

10.3 Advances in UI (Usability):

In this section we will describe the advances in UI that will additionally benefit the information retriever. The QAISR architecture makes it possible for these information retrieval benefits can be made available to the user.

10.3.1 Asynchronous Response to the Retriever

It is not uncommon in QAISR architecture for a particular question that the information retriever is seeking information on and so far there is no information creator that has updated the QB with that question bound to the answering information. In such circumstances, the information retriever may like to be notified when such a binding is created by some information creator. If the retriever would like to be notified, then they can express interest to be notified through the info retriever UI. When the retriever expresses interest in notification, the QB which will keep the list of unanswered questions and for each question a list of the people with their contact information will append the new requestor to the list of people waiting for a response for this question.

As the unanswered questions are published to help stimulate information creation of the information that is in demand, an interested information creator can make the binding of the unanswered questions with useful information.

It is fairly straight forward for the QAISR architecture to periodically scan the list of unanswered questions (or set up an event driven mechanism that would check for every new question added to the QB to see if that question has thus far not been answered—this may be more compute intensive and the implementation will make a judicious choice) and see if the questions in the list have been recently answered. If they are then the waiting retriever will receive an email notification that will let the user find the information the retriever has been waiting on.

10.3.2 Question Driven User Interface/Desktop View

In order to describe how a question driven user interface or a desktop will work, we will first list out a few relevant observations and then develop on these observations to describe the question driven user interface or desktop. This view of the desktop is proposed in conjunction with the traditional desktop model. At a high level the user can switch the view of choice.

10.3.2.1 Relevant Observations:

A desirable objective of a good user interface is to reduce the number of tasks a user needs to perform in-order for the user to perform the job at hand.

All software applications, web-sites, or any digital data can be viewed as a information response to some questions.

It is possible to bind the questions to icons and icon names that a user can save on her desktop.

It is also possible to bind the UI operations such as mouse clicks, key strokes to trigger an information retrieval step or triggering of an application which happens to be the information that is being retrieved.

10.3.2.2 How it Will Work:

From the above observations it should be fairly apparent how a user could create icons on their desktops to trigger information retrieval. To simplify the icon creation, the information retrieval will implement the functionality that will enable users to create the icons on their desktop. A user who frequently seeks news and happenings in Sunnyvale may be prone to asking the question “What is today's Sunnyvale news?” or “What is today's news from Zimbabwe?”. For this question the user creates the icon, and from next time onwards all the user has to do is click with their mouse to obtain news about Corvallis or Sunnyvale. This will enable the user to obtain news about Sunnyvale from all the sources that have created the binding to the question. When the user saves in the icon the fact that the data has to be sorted by the order of when the binding was created, the user will find the today's news first and the bindings created from earlier days much lower in the sorted order.

10.3.2.3 Significant Benefit:

In effect, portal managers try to collate the information corresponding to a particular topic such as Sunnyvale News and try to gather all the news about Sunnyvale from the sources that they scour to obtain this news. It is not uncommon for the portal managers to be less than complete in scanning all the possible sources of information for a particular topic even when a creator of the news about Sunnyvale would like to have the consumers of such news obtain the content created by them. In QAISR based solution, the info creator has to upload the [q,l,a] bindings and as soon as that is done, the retriever will obtain the news from the new source without the intervention of an intermediary such as a portal manager. This is significant for people that want to obtain all the possible responses to the question of their interest.

Also, when several portals exist and each creates its own subset of responses to a particular question that the user is interested in find answers to the user will have to scan each portal to get all the available answers to the question. This could be tedious if the number of portals are numerous. The same user that relies on QAISR technology does not have to worry about exhaustive scanning of fragmented set of responses from the multiple sources of information. In effect the user is not limited by the portal managers' efficacy in obtaining all the information that corresponds to a user question. In the next section we will describe how a user will be able to create a personal portal that is more complete in its information retrieval capacity than currently available portals.

10.3.2.4 Secondary Benefit of Protection From Denial of Service Attacks & Not Having to Remember Web-Site Addresses to Locate Information:

When the information retrieval is predominantly driven through the questions posed, then the information creators such as web-sites can store the same information in redundant locations that use different ip addresses. In such a scheme, even when a particular web-site, say CNN may be attacked by the malicious denial of service attacks the information retriever can locate the information useful to them from an alternate site without actually knowing that the site has gone down. In effect, people do not have to memorize the web site addresses but just ask the question or save the question that will lead them to the web destination of their interest. In effect, even web-sites change their domain addresses, users can locate the information of their interest.

10.3.3 Most Recently/Frequently Asked Presentation

10.3.3.1 The Problem:

With the ability of the user to create a desktop based on the questions that are of interest to user, where the questions may correspond to invocation of applications or simple retrieval of information the information management of the user can be further improved. When a user asks several questions, it is not feasible to represent all the questions that the user may ask in iconic form. Due to the limited space on a given desktop, it is not possible for all questions to be iconically represented and still be useful to the user. Once the desktop is sufficiently cluttered the user invariably will need a technique to find the right icon.

10.3.3.2 The Organization of User Questions:

In order help identify the set of icons that will be displayed on the user desktop, we will base of design on the following relevant observations on good user interface design and some the possibilities of QAISR.

10.3.3.2.1 Some Observations:

A user will always have the alternative of asking a question that will point the user to the application or information that the user seeks.

The desktop of iconified user questions is primarily to reduce the number of things that the user has to do to either retrieve an application or retrieve information. It is less effort to click a mouse than to articulate a question and type it in its entirety.

For a given user, we expect that there will be several actions bound to questions that they perform quite frequently. For instance a user may frequently retrieve news about a particular stock or a particular sport or a particular tv soap opera. The user infrequently seeks information that is different from the topics of user's frequent concern.

It is quite likely that a user when performing some work is performing the work within a greater context and there the probability of a user asking a question that is related to the most recently asked question, and sometime the user may repeatedly ask a question that has been recently asked.

10.3.3.2.2 Methodology:

Bearing the above observations in mind, we will gather the set of questions that the user poses through the information retrieval stage. With the availability of the historical data of the users information retrieval pattern, it is possible for an agent program to process the set of questions to identify a fixed number of questions (20-50) that are most frequently posed by the user and create for these questions iconic representation. Another approach could be to create a directory hierarchy of icons, but this would invariably lead for the user to step through several directories from the top level to the level at which a particular question of concern is iconically represented. In effect the user would have used more mouse button presses with a sense of ambiguity and this would be less effective than the user typing the question. As our goal of usability is to limit the set of tasks the user performs to achieve the users' objectives we by choice require the user to pose the question to the general purpose information retrieval UI, and only for the most frequently posed questions do we create the icon driven desktop. Thus the user will do the least amount of work most often in asking the questions. For the frequently asked questions, the user needs to click a mouse once and for the other questions the user poses the question.

Another bias with which the questions that are represented iconically may be organized is by including those questions that have been most recently asked in order to take advantage of the fourth observation made in the preceding section. The agent program is designed to mix the most recently and the most frequently asked questions to be presented iconically for the user.

10.3.4 Voice Driven U

10.3.4.1 Natural Language Advantage

A significant advantage in users retrieving the information by asking questions is our ability to tap into every user's currently natural ability to comprehend and use spoken languages. We will enumerate the advantages of using natural language and the situations where natural language may be less desirable.

10.3.4.1.1 A User Does Not Need to Learn a New Language to Perform the Tasks That a User Wants to do

It is easier for a user to use the vocabulary that they currently possess to achieve certain tasks, and it is difficult if they have to learn new vocabulary. A user that speaks a particular natural language with their current vocabulary may not be able to use software applications if they do not know how to express their objectives using the user interfaces that the software application presents the user with. A willing user may chose to learn the syntax and the semantics of a software application and this will add the UI of an application to the vocabulary of the user. Even the standardized user interfaces abstract peculiar semantics of a specific application and hence the vocabulary of using graphical user interface, just like natural language is evolutionary in nature. The semantics of graphical interaction and their association to tasks tends to change as different application designers overload the existing semantics to benefit from the cognitive association that is closest to the new task that they want to help the user understand based on their visual presentation. As all application development is distributed in nature no standards organization can coerce a total adherence just as language standards tend to get polluted with due justification as new concepts need to be expressed using existing vocabulary. Inventing a totally new term makes to express a concept makes it harder for people to grasp the concept without basing it on existing terminology. Thus the designers of new semantics be it in language or graphical user interface tend to base the new vocabulary on existing parlance that has the dual effect of reducing the difficulty for people to grasp the concept while it has the unfortunate effect of polluting the semantic association of a term that until now did not have the newly created association. And there will be times when a completely new language that is not based on familiar vocabulary is designed to streamline and simplify the semantics. This will make it difficult for the new users of the language to express articulately in the beginning, but over time as more people learn this vocabulary newer terms will be based on this vocabulary as enough people understand this new vocabulary.

Given the above understanding of GUI when viewed as a language and natural language. A designer of any user interface has to make choices based on the problem at hand how much of the design is based on the vocabulary of the greatest number of people, and how much of the design is based on terms and graphical actions that are unlike what the user is familiar with. In terms of improving the immediate adoption of a user interface by the largest number of people, the designer is better served by basing the design on semantics that most people understand despite the fact that it can pollute the very vocabulary that people currently use and that it may not be the simplest way design the user interface. As we expect the solution that is intended to be used by the greatest number of people as their first interaction with a desktop user interface as a mechanism to find information, we will be best served if it is based on simple GUI that most people understand and natural language that is already learned by significant world human population.

10.3.4.1.2 A User Can Use Common Speech

While theoretically words can be invented to map any graphical interaction, and the more mathematical languages such as Boolean operations can be used to compose Boolean expressions that some times are used to compose searches, most people are better capable of using their speech to compose questions with less difficult grammatical constructs. In order to leverage this ability of people to help them find information, having the users pose questions to retrieve information will help more people to obtain the information that they are seeking. And since QAISR unlike other technologies enables users to retrieve information based on the questions that they can device naturally, we can make it possible for people to use vocal speech to obtain the information if they prefer speaking to typing the question in the information retriever UI.

10.3.4.1.3 Richness of Vocabulary

As human beings that have a rich vocabulary of spoken language words, and use the vocabulary to articulate thought it is easier for us to express what we are seeking in a spoken natural language when the inquiry is done in the absence of knowing of any software/hardware tool that may have an advantage over the natural language for specific queries constrained to the scope of the tool. In other words, we are more capable of asking the question “What is the price of oil in Manila?” if we did not already know of a tool that lets you enter the name of the city to supply you with the price of oil in the city. The first instance required the information seeker to articulate the users thoughts into spoken language, but it required the user to type in a string of words. If on the other hand the user knew of the tool and has the tool iconified on the user desktop, the user would have had to type in name of the city and that would have provided him the answer. Considering all people cannot be expected to know of all the tools and what the tools can provide them with by using specialized GUIs, the user will benefit tremendously if the user can obtain what they seek by formulating their request in spoken language. There is no comparable GUI idiom as yet that the vast majority of people know to compose generic questions that are requests for information. Thus the richness of vocabulary in natural languages make them more suitable for making the first order request for information that may then lead the information seeker to a tool that is specialized for a particular request. In effect the absence of a tool to be discovered based on the natural language question that a user is expected to pose, the tool usage among the prospective beneficiaries of using the tool will be less than possible. This can have a direct economic impact on the creators of the tool.

10.3.4.2 Designing Voice Driven Desktop

Based on our description of question driven UI, and the above subsection enabling a user to use voice to retrieve information and interact with applications requires a speech recognition application entering the questions in the information retriever UI. The general QAISR approach to information management makes it eminently more friendly for voice driven interaction with information. This in no way precludes the graphical user interaction, but only makes it possible for multiple ways to interact with information and retrieve information.

10.4 Context Sensitive Information Retrieval

The abstraction of internet gidgets by definition create context for the information that is being retrieved. The context could be the web-site that has placed UI on their web-site, or a software application. This context information helps in benefiting the information creator and the information user.

10.4.1 Policy of Ordering the Responses

When a user asks a question, QAISR by policy will present the information that is related to the context (owned by the creator of the web-site) prior to presenting answers by other information creators.

10.4.1.1 The Benefits

This policy gives an additional incentive to information creators in order for them to participate in the QAISR solution. The information creators will not be harmed by receiving responses from the same creator for questions asked at one context as they have a chance of being more coherent than related questions answered by disparate sources.

10.4.2 Policy of Hiding the Questions Asked

When a user asks a question, QAISR by policy will allow information publishers to prevent publishing questions asked at a give web-site in order to have an opportunity to create the information that a user may seek when they are asking the question from their web-site for a finite period of time.

10.4.2.1 The Benefits

This policy gives an additional incentive to information creators in order for them to participate in the QAISR solution.

10.5 Information Retrieval of Finding Physical Objects

One very interesting application of QAISR architecture is that it makes it possible for us to create a method that can help people track and find physical objects. By using the techniques described in POQAISR (Physical object question associated information storage and retrieval) physical objects can be located by information retrievers just as they locate information. This in effect helps users to reduce the time spent on trying to locate any physical object that they own when they do not remember where they placed a certain physical object. This architecture has applications in inventory auditing, and also helps owners keep track of pilferage by keeping a trail of when objects were added and removed from a container.

10.6 Meta Information Retrieval (Question Data Mining)

10.6.1 Unanswered Questions:

All the questions asked to have QAISR lookup responses do not necessarily have responses, as we had mentioned in the subsection that describes asynchronous response to the retriever. Information creators will benefit from knowing what questions are being asked by information retrievers. In particular the information that they provide can generate revenues for the information creator.

10.6.2 Questions on a Topic:

Information creators will also benefit by having access to the questions that people are asking about a particular topic for which they themselves are trying to create some information. For instance an information creator will want to know that the people that are asking music CD related questions tend to ask questions of the form:

Where can I buy Dire Straits CDs?

Where may I buy Dire Straits CDs?

What is a good place to buy Dire Straits CDs?

The creator will be enabled to obtain such information by doing keyword search on the openly published question data from the QB.

10.6.3 Question Based Non-Invasive Market Intelligence:

If a car manufacturer new that several users are asking questions about eco friendly cars more than gas guzzling cars, it can help the car manufacturer to gauge the consumer choice in a non intrusive way that surveys and polls invariably tend to be. The open QAISR QB will enable creation of market intelligence that is truly non-intrusive.

10.7 What is a Question?

At a very high level a question is a string of characters in one of the natural languages that when parsed by those that understand the language interpret as a string that elicits a response of some kind. Depending on the response, and the knowledge context of the person reviewing the response, the validity of association between the question string and a response is ascertained.

10.7.1 Question, Function/Method Equivalence:

In programming languages, the use of functions and methods are quite similar to questions to the extent that the functions and methods retrieve or compute the information that corresponds to the method, function encoding signature in a high level programming language. It is not uncommon for people asking questions to provide contextual information, besides the question to reduce the possibilities of inappropriate answer. This contextual information is equivalent to the data arguments that are supplied to the function and method calls. In Qme, the information retrieval sub-system can compose a method/function call for an object based on the question composed by the retriever of the information. This ability to convert a question into a method call or a function call is another of the numerous strategies that will help in making information more findable.

11.0 Complete Architecture:

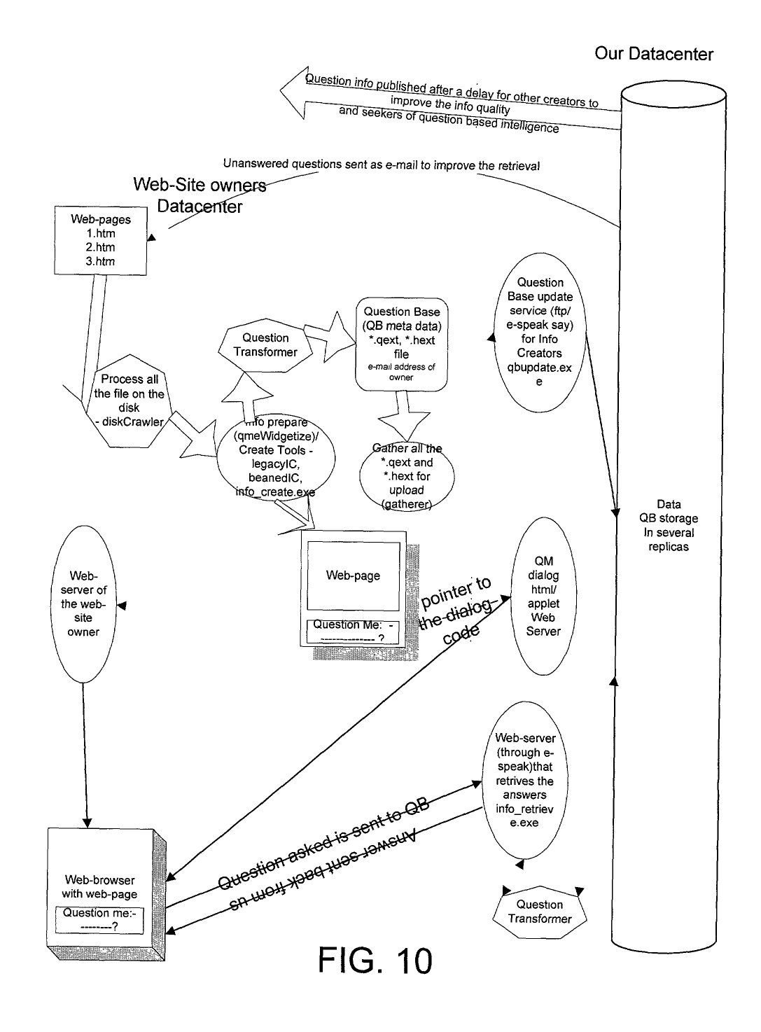

11.1 The QAISR Architecture Diagrams, as Shown in FIG. 10

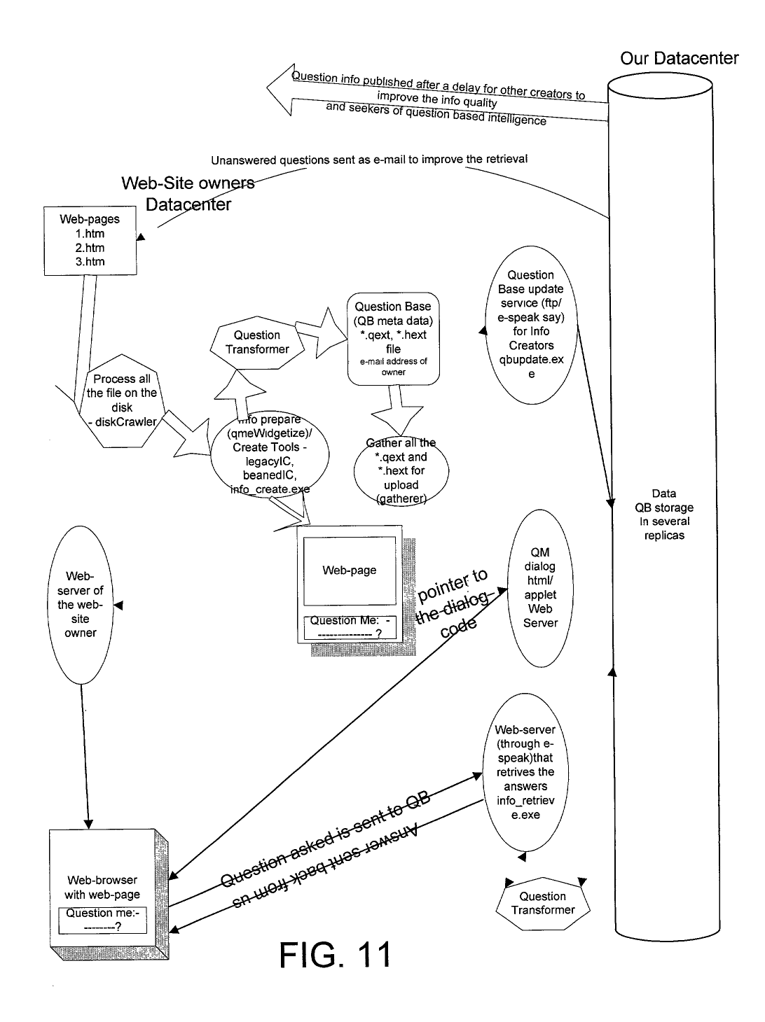

Solutions and advantages of QAISR architecture using internet gidget model are shown in FIG. 11.

The above described QAISR architecture provides the framework for various useful information retrieval solutions. In this section, we will enumerate some plausible solutions using QAISR architecture, and provide pointers to the documents that describe and illustrate the architecture of the complete solutions.

1) Internet “QAISR”

2) Intranet “QAISR”

3) Single-system “QAISR”

11.2 Internet “QAISR”

The Internet “QAISR” solution makes it possible for a solution that can make retrieving relevant information from all the public information on the internet. The Internet “QAISR” architecture is based on the architecture described in this document. The internet solution that uses QAISR and internet gidget architectures is called “Qme”. The architecture described in this document specifies all the architectural components necessary to implement Qme internet solution. The QB that maintains the data for the entire published information is called Universal QB.

11.3 Intranet “QAISR”

The Intranet “QAISR” solution makes it possible for enterprises to improve the quality of information retrieval within the enterprise, while honoring the access control policies of the organizations within the enterprise. The intranet QAISR solution is interconnected with the internet QB to ensure ubiquitous access to all accessible information.

11.3.1 Special Architectural Implications:

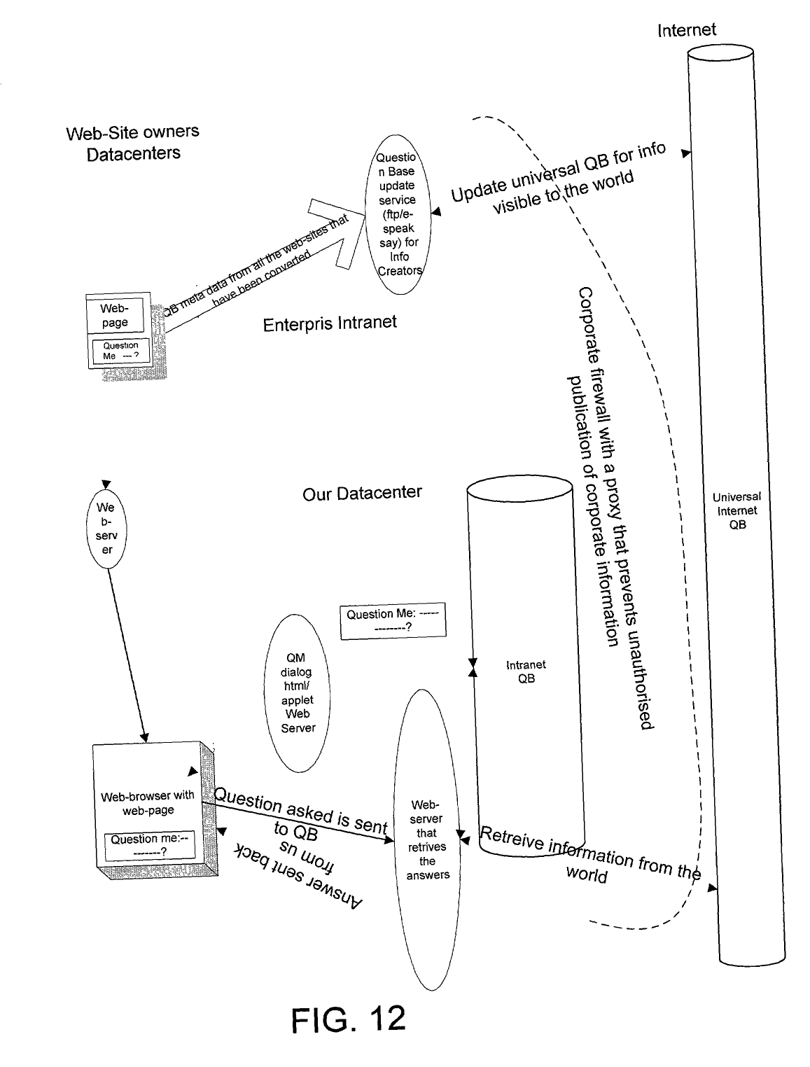

The intranet QB and the universal QB are connected based on a policy. The information that an enterprise wants to publish to the world will require intranet QB to push the meta data corresponding globally accessible information to the universal QB. The information creators have a capacity to control which set of questions are pushed for publication. Refer to FIG. 12.

When a information retriever asks a question at a web page within the enterprise, the intranet information retrieval module can also retrieve information from local QB as well as universal QB. The formatting of the information retrieved should make it easy for the viewer to distinguish information obtained from the local QB from the universal QB.

11.4 Single-System “QAISR”:

The Single-system “QAISR” solution makes it possible for individuals that want to improve the quality of information retrieval of their personal information. It also, provides the necessary functionality for them to propagate the information that they want to be made available to the intranet, and the internet “QAISR” solutions. The features necessary to make the Single-system “QAISR” solution are slightly different from the above two solutions. The QB of a single system user is called a personal QB.

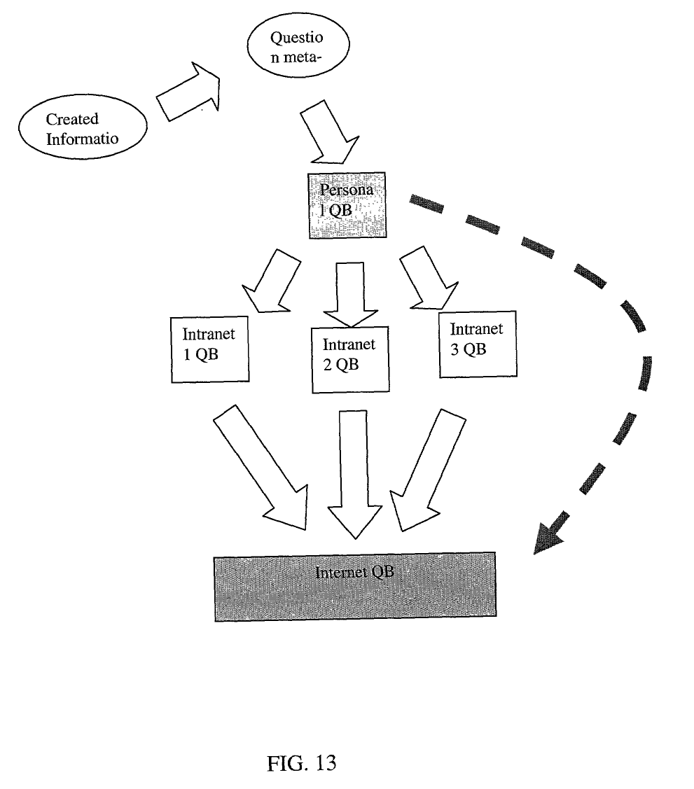

Pictorially, the world that every individual information creator in the world views resembles the FIG. 13.

Where Intranet1, Intranet2, Intranet3 are the groups that the information creator belongs to, be they their employer, or any organization that they belong to.

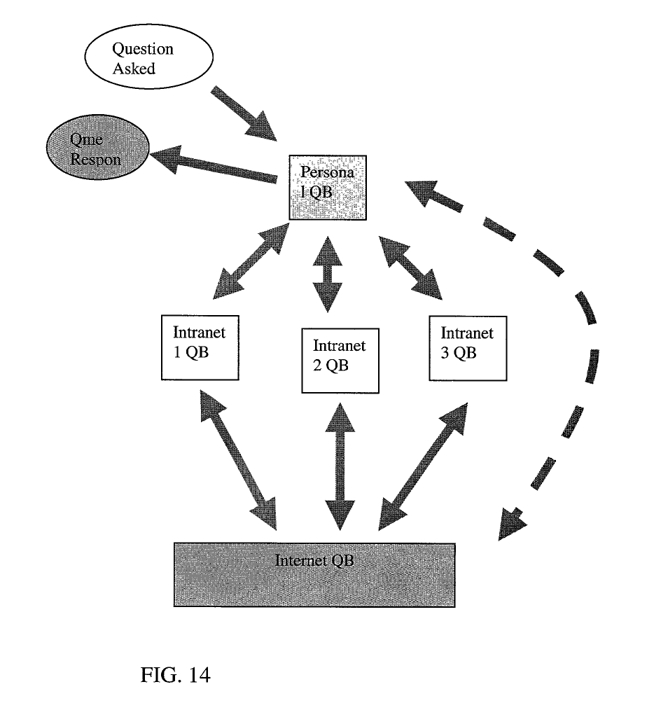

Pictorially FIG. 14 represents the world that every individual information retriever in the world's view resembles the following.

12.0 Implications of QAISR Architecture

12.1 Information Feedback Loop

From FIG. 6. and the other architectural diagrams one can observe how a loop is formed between information creation and information retrieval. This loop completes the information feedback loop that enables the creators of information to improve the quality of the information that they create based on the feedback that they receive from the information retriever. In the early stages of information creation the quality of how easily the information is retrievable can be less than what it potentially can be as the information creator may not be able to guess all the kinds of questions that may be asked at their site. Over time as more information retrievers ask questions pertaining to a topic be it at their site or some one else's they will invariably contribute to the improvement of the quality of information.

12.2 Distribution of the Computing That Improves the Quality of Retrieval

By the very design QAISR architecture reposes the responsibility of improving the quality of information retrieval on the information creator. This in effect distributes the effort involved in improving the quality of the retrieval unlike the information retrieval technologies that concentrate the effort involved in the improvement of the quality of retrieval.

12.3 Reduction in Number of Hops to Find the Information

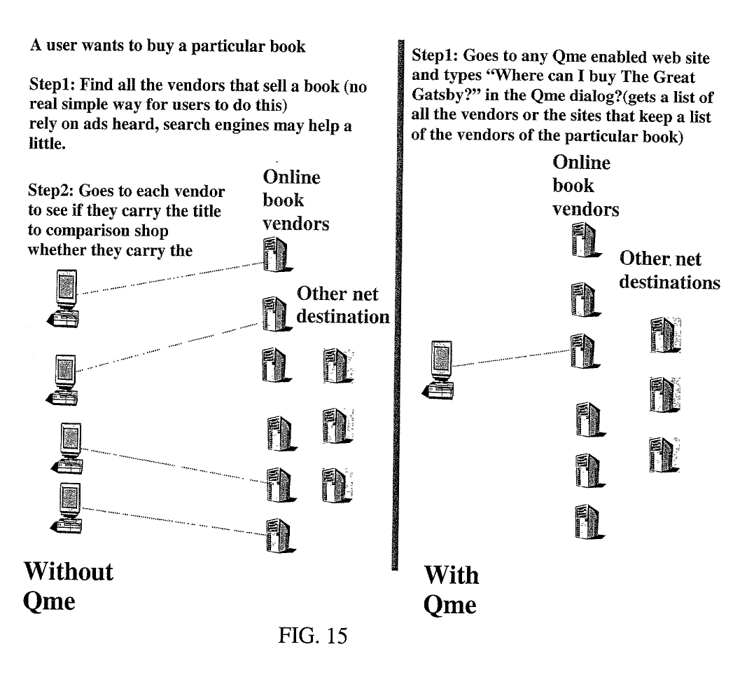

The following schematic FIG. 15 illustrates how QAISR/Qme helps in reducing the number of hops a user need to hop in finding the useful information.

12.4 Salient Characteristics of QAISR Architecture:

Qme moves the search improvement processing to the information creators.

Intelligent structuring of information.

The info creator can improve searches based on what is asked at their site.

Questions are bound to the information, by the creators of information.

The creators of information keep the info and the questions encapsulated as the total information.

Traditional info retrieval search engines process stored data to create a searchable index.

The relevance of the what is sought is established through a generic heuristic.

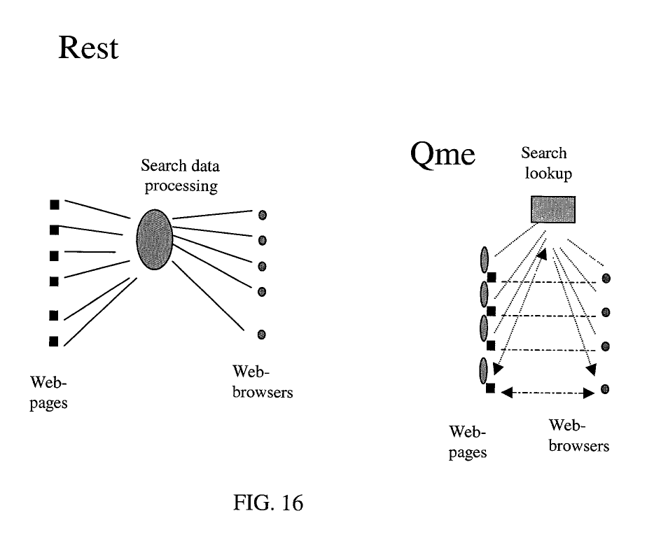

Tools have been created to facilitate info creation to be useable in a QAISR info retrieval Refer to FIG. 16.

12.5 Additional Analysis

A more rigorous analysis of the value of QAISR architecture that explores the probability of an information retriever discovering the information that they are seeking, and the algorithmic analysis of the information creation and retrieval for space and time complexity are beyond the scope of this document. This analysis has been performed and the interested reader is referred to contact the author of this document to obtain this analysis.

13.0 Security in QAISR

13.1 Authorization in QAISR

Authorization plays a role in two different stages of QAISR architecture. The first stage is the one in which the information creator wants to propagate only portion of the question associations to the QB hierarchy such that private information or even the knowledge that the information creator has the information to leak out. The second place where authorization plays a role is where the information creator wants to control who can see the response to a question. This second scenario may be of significance in enterprises that do not want the questions such as “What is the payroll of the company?” to be widely locatable by all members of the enterprise.

13.1.1 Authorized Publishing to QB

QAISR architecture on implementation will specify the syntax that will enable information creators to stipulate which portions of the question meta-data can be propagated to the central QB. This will make it possible for people to establish a policy of what information that they create becomes easily locatable.

13.1.2 Authorized Viewing of Published Information From a QB

In corporations that would like to classify information such that access to the information is controlled would benefit from QAISR QB enabling them to provide responses that are based on the user identity. To this extent the information retriever that interfaces with the QB is the application that checks on the policy before making a presentation that the retriever views. In order to simplify the usage of access control/authorization subsystem QAISR will base its implementation pluggable, such that inhouse authorization subsystem that is used for governing other authorized access in the enterprise is also the one the enterprise uses for protecting information access of QB mediated info. For those enterprises that do not have an inhouse authorization solution, a reference authorization subsystem is supplied.

13.2 Layperson/Expert Evaluation of Information

13.2.1 The Problem of the Accuracy of the Question Binding

It is quite plausible for people to bind inaccurate information as a response to a question. This could be driven by motives of deception and economics.

13.2.2 The Voting Heuristic

In order to thwart such attempts, QAISR proposes a way for people to register their disapproval of blatant misrepresentation. The voting of the information presupposes that only the dissatisfied will register protest, and for every access to a response by Qme if the retriever does not register a protest then Qme assumes that the retriever is content with the veracity of the response to the question.

13.2.3 The Expert Voting

While the opinion of a lay person may indicate the value of the information in terms of its ease of understanding, an experts opinion is more indicative of the correctness of the information. As QAISR can categorize the questions into general categories, a way to glean experts votes from all the votes cast serves the purpose of validating the correctness of the responses to the questions asked. QAISR proposes a method by which the information retriever is authenticated for their credentials/pedigree in a university or a reputed institution to determine if the reviewer is an expert on the field to which the question has been categorized. The authentication scheme will involve PKI based infrastructure involving institutions that certify expertise. In effect, this will replicate the refereeing of information in reputed journals.

13.2.4 The Impact on Standardization

This scheme will have other ancillary benefits in the area of standardizing. People in all walks of life try to standardize information and specifications in order to minimize chaotic development. Construction industry may want to standardize brick dimensions, and software industry may need to standardize data formats. Standards tend to become de-facto standards if large number of people use a particular specification. The combination of how many people asked and assented to a question such as “What is the standard size of brick?” will be determined as a combination of the number of people that approve of an answer to the question and the number of experts that approve of the intrinsic appropriateness of the response. For instance a negative dimension for the above question is expected to meet an experts disapproval irrespective of popular approval. This of course is premised on the integrity of the expert to ply their trade with the benefit of education the institutions impart.

This mode of standardization precludes vested companies to control the standards even when the significant expert opinion on the usefulness of the standard that is sometimes peddled by corporations with vested interests.

13.2.5 A Criteria for Sorting the Presentation

The voted/refereed information will provide the retriever to chose how to order their presentation with the constraints of how the information retriever presents responses to a question asked, the constraints being the ones that will always present the response from the web-site where the question was asked etc.

13.3 Protection From Plagiarization and Illegal Dissemination

13.3.1 How it Works

In order to describe how Qme/QAISR architecture can be used to track down illegitimate dissemination of digital information, we will use the example of a specialized application that is built on top of the QAISR architecture to facilitate the said protection. This application is called musicQme as it was originally designed to help with tracking illegal distribution of music information. However the same technology can be extended to track illegal distribution of all information. Other technologies such as digital watermarking, corpus analysis approach the problem slightly differently. While digital watermarking will help determine if some one is illegally using some digital data, one still needs to have access to the document and it is non-trivial to gain access to the location of the document in the absence of QAISR. Similarly there are some technologies that scan corpus of text to detect plagiarization with reasonable but limited success [SHGA95]. Even this technique is not useful in tracking illegitimate distribution of text. Also this approach suffers from its inability to track pilfering and plagiarization of non-textual data.

13.3.2 Introduction of MusicQme:

In this brief section we describe the elements of the architecture that are peculiarly unique to musicQme. It is assumed that the user has some familiarity with the Qme architecture. We will partition this document into 1. the description of the musicQme architectural elements, and 2. the rationale behind the value proposition to the digital music vendors.

13.3.3 The MusicQme Architectural Elements:

The architectural elements that are unique to musicQme are:

1. Plagiarization/illegal distribution detection agent

2. Plagiarization/illegal distribution detection deamon

3. Question to DB (suspect music vending) query converters

4. Music vendor DB questionizers

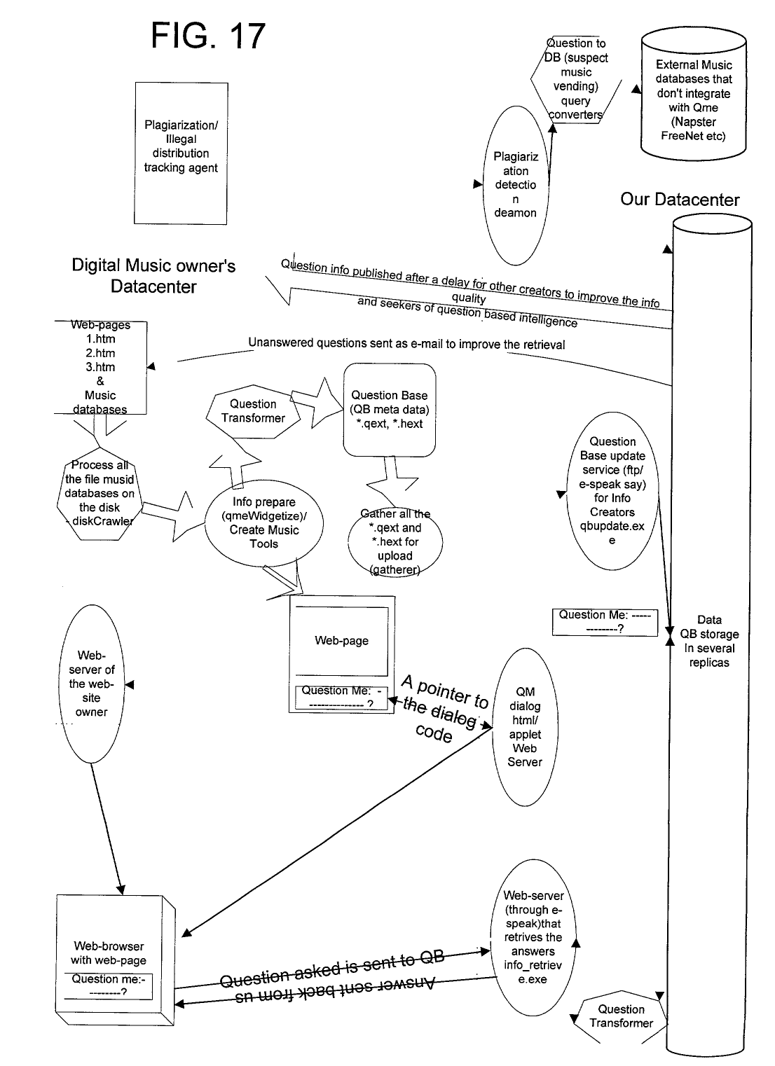

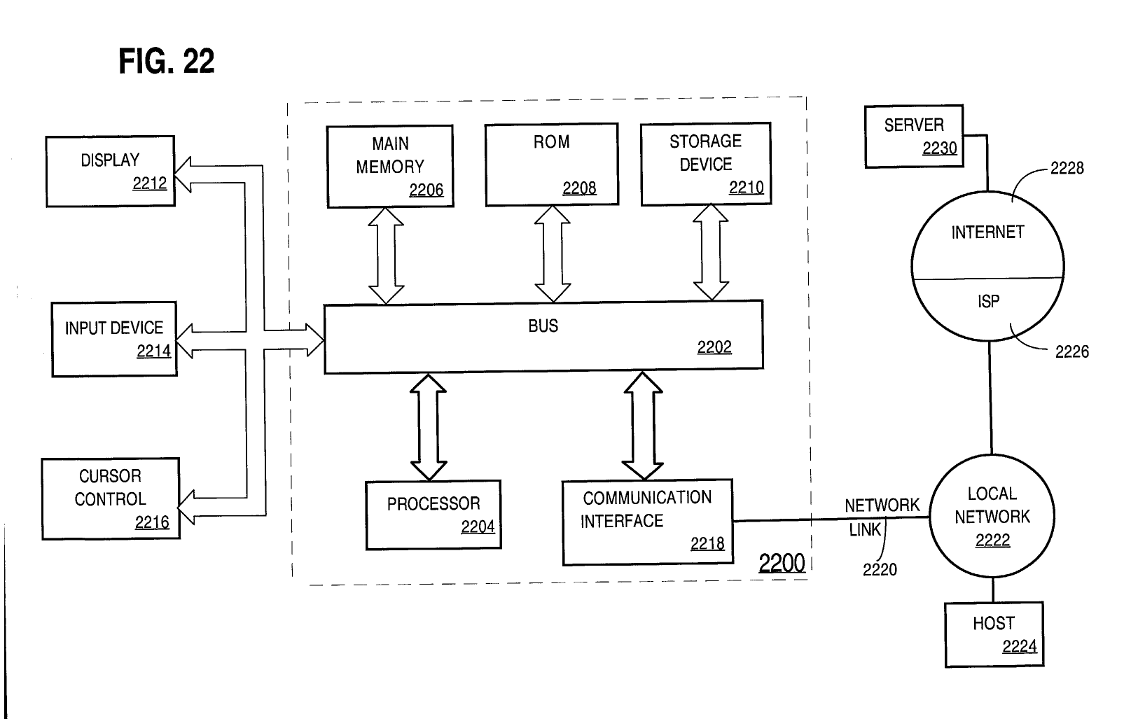

We will briefly describe each of these modules with the help of the following figures depicting the architecture pictorially. FIG. 17. shows how a single legitimate online music vendor interacts with the Qme subsystem as well as the way the Qme subsystem tracks down illegitimate distribution and FIG. 22. depicts how a community of music vendors interact with the Qme subsystem.

13.3.3.1 Plagiarization/Illegal Distribution Detection Agent

The plagiarization/illegal distribution detection agent software (a java application that is specially provided to the subscribing vendors) will periodically run itself on the client computer. o This software module has two functions, namely agent mode usage function and administrative mode usage function.

Its inputs:

The local (or QB stored) question data that is owned by the particular music vendor. List of owner approved non-owner sites the owner does not consider to be prospective illegitimate responders to the questions that are answered at the owner's site.

In the agent mode usage function:

The agent that executes periodically as a batch application or on user request, checks to see if any site answers to a question that is in the owner's question list is answered by an unapproved source. The agent, then generates a report for the owner to review. The report will enumerate those responses for whom the answers from any new sources may have to be categorized into approved list or initiate action that will stop the illegitimate distribution of digital information (legal recourse, warning and such).

In the administrative mode usage function:

The administrator periodically processes the reports generated by the plagiarization/illegal distribution detection agent.

The agent when performing these above function connects to the “Plagiarization/illegal distribution detection deamon” and feeds the questions in the list of owners questions, and retrieves the responses from Qme that are obtained from the Qme general purpose question base and the responses generated by the “Question to DB query converters” that track the un-cooperative music vendors.

13.3.3.2 Plagiarization/Illegal Distribution Detection Deamon

For the purpose of tuning the load on the sub-system that helps in the tracking of plagiarization and illegal distribution, a separate deamon (server) process is launched on the Qme's data warehouse. This deamon for every question that is given to it by a “Plagiarization/illegal distribution detection agent”, it will route the question to the “Question to DB (suspect music vending) query converters” and the QB as would the info-retriever subsystem by actually vectoring through the info retriever subsystem. It would then collate the responses and send them over to the agent.

13.3.3.3 Question to DB (Suspect Music Vending) Query Converters:

Not all on-line music vendors may be willing to participate willingly in the Qme configuration. In order to thwart the people that do not participate from engaging in illegal distribution of music, Qme team will manually track to determine the popular internet locations that have large usage. For these destinations, a separate software module that maps some of the question's such as “Where can I download songs by Shankar Narayan?” into an automated web-query and use the output generated to be fed to the Plagiarization/illegal distribution detection agent.

13.3.3.4 Music Vendor DB Questionizers:

It is expected that most of the online music vendors have a database of some kind where they keep their product data. In order to automate the process of creating questions (for uploading to Qme) for music vendors, a special module is developed by the MusicQme team. This module takes arguments such as “Musician's name”, “album title” to be substituted in parameterized questions such as “Where can I download songs by Argl?” to generate several questions automatically when the music vendor modifies their database.

Besides the questionization, the music vendor database is augmented to store for each unique music merchandize record, other additional fields that maintains the list of other legitimate vendors URLs etc. These field values will be used in creating input data for the “plagiarization/illegal distribution detection agent” that it uses to check for authorized respondents to the questions owned by the legitimate vendor.

13.3.4 The Rationale Behind Value Proposition for Digital Music Vendors:

Besides the numerous advantages that have been enumerated for Qme that are not targeted to musicQme, the fundamental value proposition to those that are trying to thwart the people that undermine the economic value of digital information by selling it online.

The illegal sales that happened prior to the internet were in small enough scale to not undermine the economic value as they are able to do with the internet in a fundamental way that reduced the incentive for creating music content.

However, unlike the pre-internet bootleggers the internet peddlers will have to publicly make it possible for people to find them to reach the scales that they are able to. It is this factor that helps us track the large unco-operative music vendors.

The legitimate vendors will benefit from the advantages that are delivered by the “Qme” technology, and also will be able to include this as an additional to increase the cost barrier for those that will contemplate selling digital music illegally.

13.3.5 Stages of Value

The community of music vendors will not be able to track down plagiarization and illegal dissemination of the information they want to protect in the early stages of QAISR usage. This is due to the fact that all the legitimate and illegitimate peddlers of this information have not adequately questionized their data for them to base their tracking on the responses elicited by questions to a QAISR subsystem. In the early phases of QAISR adoption, the primary benefit to the vendors of digital information is the improvement in other locating their availability. Thus the advantages of Qme that are immediately realizable are short term benefits to the music vendor. However, as QAISR gains in adoption due to the intrinsic value of the short term benefits and more people vector through Qme based information retrieval to discover sources of information, the people that do not bind their information to the leading questions will have an economic disincentive at that stage to not questionize. As more people questionize their data, it becomes easier for detecting illegitimate sales. In effect the fact that illegitimate sales can be detected on an ongoing basis after the initial phase, where the primary incentive is to make information locatable, would be an incentive for early adoption of QAISR usage to the legitimate vendors of digital information.

14.0 Scalability Enhancement in QAISR Architecture:

The scalability in QAISR architecture is accomplished by partitioning the QB when a QB reaches the limits of size beyond which it is difficult to keep it on a single physical device. The questions which are the primary key that is used to locate information, we can use the natural partition of alphabetical data to partition a QB.

14.1 How to Make a QB Scalable in size:

Let us explain how we do this using an example. If our QB contains data of the form:

| | | |
|---|---|---|
| Questions | Locations | Attributes |

Are there people living in
Greenland?
How can I build a car
stereo?
How can I time travel?
What is the purpose of
smoke alarms?
Where is Finland?

In the architecture of QAISR described so far, the info retriever passes the question to the QB to lookup the record with the selected question.

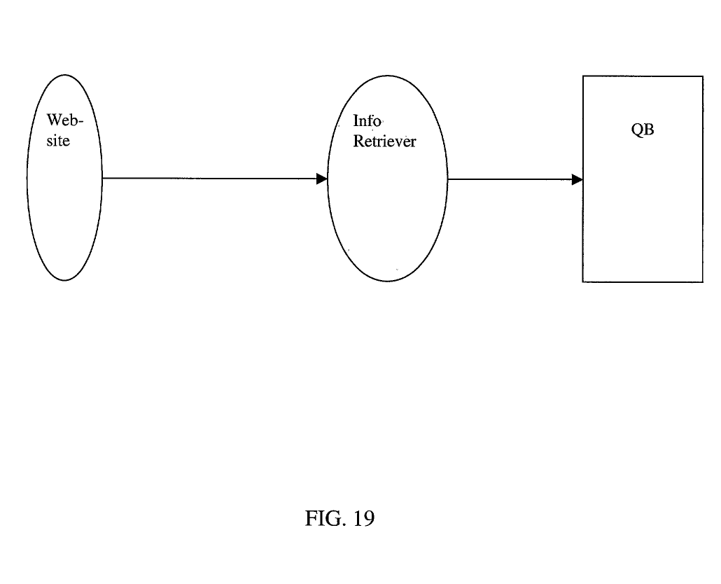

Pictorially in FIG. 19 is a blocked diagram depicting an architecture that uses an unpartitioned QB.

The same QB can be partitioned into multiple QBs such that all the first letters in the questions in the QB are the same. In such a partition we will have 3 QBs for the above example of the form.

| | | |
|---|---|---|
| Questions | Locations | Attributes |

QB1:

Are there people living in
Greenland?

QB2:

How can I build a car
stereo?
How can I time travel?

QB3:

What is the purpose of
smoke alarms?
Where is Finland?

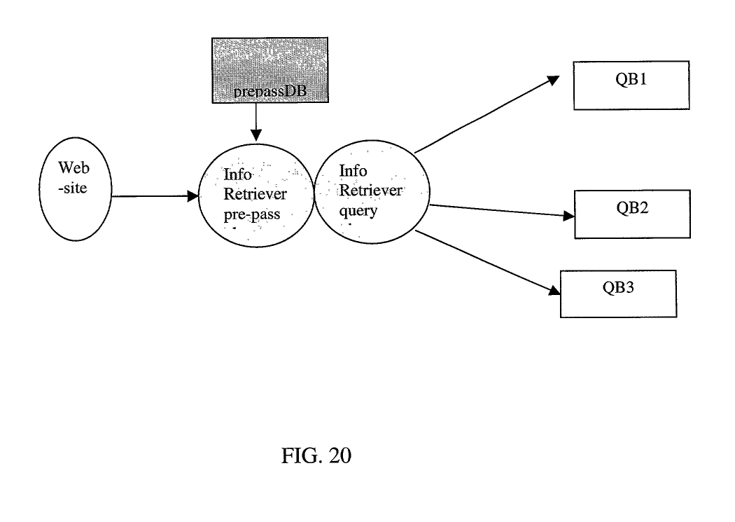

Now in order to find the location of the response to the question, the info-retrieve engine itself has to be partitioned as shown in below in FIG. 20 where there is a pre-processing stage and the actual question retrieval stage. The preprocessing stage uses a pre-pass table of the form, called prepassDB.

| Number of letters to lookup | The prefix | The location of the QB |
|---|---|---|
| 3 | A | QB1 |
| | How | QB2 |
| | W | QB3 |

Note that even though 3 letters are looked up, the prefix can be shorter than three letters.

In practice, at any given time we have a collection of QBs, and the current preProcessDB that are growing based on the question data that is being updated by the creators of information. In order to avoid reaching limits of physical devices, a partitioning application is created that partitions the QBs with increased numbers of lookup and balances the sizes of the QB. Refer to FIG. 20.

14.2 How to Make an Info-Retriever Scalable in Handling Increased Load:

The above two tiered separation of the info-retriever and the QB makes it possible for creating a many to many mapping between QBs and info retrievers.

14.2.1 Dynamic Load Balancing:

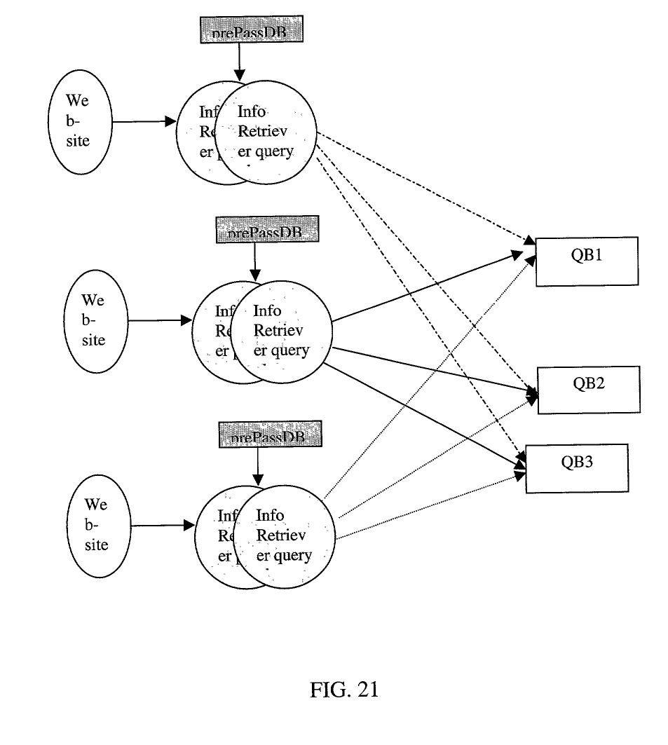

From the above FIG. 21 it is clear that additional info-retrieve engines can be spawned on different machines and effectively they will be able handle additional traffic. Each info-retrieve engine keeps a list of the other info retrieve engines active and re-routes the load as new requests seem to overwhelm current capacity. A load balancing subsystem will point the re-routed requests to a different info-retriever subsystem

14.2.2 Static Load Balancing:

The QmeGidgetize application that inserts the specific info-retrieve destination that a particular internet gidget is pointed to, chooses different internet gadgets in order distribute the first ino-retrieve subsystem each of the gidget points to. The gidget code on the web-pages also can use a hierarchical order to pick among multiple destinations.

15.0 Applications of QAISR/Internet Gidgets:

15.1 Problems Solved by QAISR/Qme:

Improves the economic value of information accrued to the information creators thus unleashing market dynamics to dictate information supply and demand.

Improved probability of retrieving the exact information sought (and probability is 1 if the information is previously bound to the question) and thus the improved information efficiency.

1. Notification of the information created as a response to an unanswered question (as the user can register to receive the answers to a question on an ongoing basis or the first few responses as soon as some one answers the question anyplace on the planet)

Distributed effort to improve the quality of the info access by the creators (unlike search technologies that rely on their secret/closed algorithms)

Context (web-site, user info) sensitive info retrieval improves the quality of the searches for both retrievers and creators.

By knowing the questions asked by the consumers of information, the creators can better serve the target audiences. Improved gathering of intelligence about the information being sought by people.

Makes it possible to locate information that is not openly published such as books sold.

Reduces the overhead of retrieving already retrieved information within enterprises, if Qme is deployed within intranets.

Helps in improving the usability of web and ordinary software applications, by binding questions to particular functionality.

Makes it possible for businesses to target the information based on what is being sought about their products etc.Uniqueness of QAISR

It can be discerned by the reader of this document that the problem solved by QAISR architecture is some ways similar to the problem solved by traditional search engines. However there are some significant differences that make this different from traditional solutions that enable one to search for information. Please refer to the “The effectiveness of the QAISR based information retrieval engines” [SHAN00a] for detailed discussion on this subject. However the following paragraph captures the unique aspect of QAISR architecture.

The unique aspect of QAISR architecture based solution that makes possible a better information retrieval, is the precise association between the question,location pair to the pointer of information at the location value in the pair corresponding to the question. The fact that the question,location pair is separated from the information itself to do the lookup facilitates an efficient binary retrieval mechanism.

One should also differentiate composing answers to questions asked (as done in news forums, expert forums etc) with composing plausible questions for any given information which is at the crux of this architecture. The effort for information creators is the reverse of answering questions, which is to bind plausible relevant questions that elicit the information created as an answer that is the central aspect of this solution.

Here is an enumeration of several unique aspects of Qme:

Binding a question that elicits the information as the answer to the question with the info itself. And, this is done by the creators of the information.

Distributed points of access to the service

Context sensitive search based on the information currently being viewed

Distribution of the effort to improve the quality of the search.

Retrieving pointers to closed information that can be only purchased.

Notification of the creation of info if a question is unanswered.

For more information on the uniqueness of QAISR architecture and the analysis that compares this architecture with other techniques for information creation and management, the reader is referred to the documents referred in the appendix for references.

15.3 Some Advantages to Information Creators in Using Qme/QAISR

Access of their information from multiple web sites and not just theirs.

Makes it possible for context sensitive retrieval of the information created.

Knowledge of what information is being sought by the consumers of information non-intrusively by mining the questions that people ask.

Closed information (books) can be better accessed by information retrievers by finding pointers to the info in the books even when the books are not openly published online. (Quality of shopping for books online can be improved.)

Democratic review of the quality of their information.

Third parties creating useful information based on the questions asked at the information creators site. (if the creator finds this effective)

Frequently asked questions maintained by people are truly based on frequently asked questions.

Protection from denial of service attacks as the ip address values and domain names need not be bound to the information that is disseminated

Protection from illegal dissemination of information and plagiarization of information.

Review of information based on the validity by experts in the field.

Provides the infrastructure that improves standardization of information, be they APIs, data formats, or brick sizes.

Ensures that information creators control when the questions asked at their site become public.

Ensures authorized access to information.

Decentralization of the effort that improves the quality of information retrieval.

Making it easy for people to find information contained in databases using parameterized question creation techniques.

Making it possible for software creators to help in the information created by software applications to be discovered more easily

Making it possible for physical objects to be easily found by the owners of physical objects when POQAISR is in use

And many of the benefits from improved quality of precise searches.

15.4 Some Advantages to Information Retrievers in Using Qme/QAISR

Context sensitive retrieval of information

Precise match between the information sought and the information retrieved.

Searching for information using the key words found in questions instead of key words contained in entire documents, thus finding the questions that closely match the questions that need to be answered

Location sensitive retrieval will help sort the information that has location significance (Where can I see the movie xyz?)

Democratically and expert reviewed information for a specific question.

Notification of creation of info based on a question that originally was unanswered using asynchronous responses.

Ability to make better purchasing decisions using the questions answered by the information in a book.

Benefit by the same question being asked by some one else, thus they helping in creating non-existent information that you now need.

Benefit from people binding questions to information rather than heuristics that poorly approximate people.

Reduced hops to obtain information contained in numerous web-databases.

Making information created by software applications to be discovered more easily.

Makes it possible to create question driven user interface and desktop that when enabled with voice will lead to more sophisticated user interface.

A desktop that is based on most frequently asked questions and the most recently asked questions.

Ability to track down and find physical objects

Ability to do instant audits of inventory owned by an individual

Reduction in cost of audits of inventory

Ability to track pilferage of physical objects

All the benefits of improved quality of searches.

15.5 Additional Usage Scenarios:Businesses Will Use Qme to Make Pull Marketing Possible i.e. Provide Information Based on the Customer Asked Questions.

Consumer review and expert (medical/legal etc.) sites will provide answers to the questions that are asked of them, and need to do it once to benefit from subsequent asking of the same question.

Corporations can deploy this intranet. This will help in the same question if asked once will not require the same effort on behalf of the answerer to answer the second time onwards.

Book publishers can create the questions answered by the books they are selling and this will make it possible for people to find the books that have answers to their questions.

Also, the book purchasers can get to view all the questions answered before purchasing a book thus improving the quality of their purchases.

The above applies to all products that are sold. And the user can benefit from all the questions asked by previous purchasers.

15.6 Scalability, Performance, Security:

The architecture is distributed and hence by design scalable.

The immense potential for parallalization in the architecture lends performance tuning opportunities based on the load. [SHANOa]

Privacy policy will ensure the creators and retrievers that the only info that they are willing to share will be exposed.

Access control, authorization using PKI will secure the overall solution.

16.0 Conclusion:

This document provides the starting point for explaining the core technology of “QAISR” architecture, and provides pointers to how the technology can be utilized in the improvement of “information retrieval”. It should be noted that the quality of information retrieval is not confined to text based information, but information that is available by using software applications, information related images, objects of any kind.

### Hardware Overview

FIG. 22 is a block diagram that illustrates a computer system 2200 upon which an embodiment of the invention may be implemented. Computer system 2200 includes a bus 2202 or other communication mechanism for communicating information, and a processor 2204 coupled with bus 2202 for processing information. Computer system 2200 also includes a main memory 2206, such as a random access memory (RAM) or other dynamic storage device, coupled to bus 2202 for storing information and instructions to be executed by processor 2204. Main memory 2206 also may be used for storing temporary variables or other intermediate information during execution of instructions to be executed by processor 2204. Computer system 2200 further includes a read only memory (ROM) 2208 or other static storage device coupled to bus 2202 for storing static information and instructions for processor 2204. A storage device 2210, such as a magnetic disk or optical disk, is provided and coupled to bus 2202 for storing information and instructions.

Computer system 2200 may be coupled via bus 2202 to a display 2212, such as a cathode ray tube (CRT), for displaying information to a computer user. An input device 2214, including alphanumeric and other keys, is coupled to bus 2202 for communicating information and command selections to processor 2204. Another type of user input device is cursor control 2216, such as a mouse, a trackball, or cursor direction keys for communicating direction information and command selections to processor 2204 and for controlling cursor movement on display 2212. This input device typically has two degrees of freedom in two axes, a first axis (e.g., x) and a second axis (e.g., y), that allows the device to specify positions in a plane.

The invention is related to the use of computer system 2200 for implementing the techniques described herein. According to one embodiment of the invention, those techniques are performed by computer system 2200 in response to processor 2204 executing one or more sequences of one or more instructions contained in main memory 2206. Such instructions may be read into main memory 2206 from another computer-readable medium, such as storage device 2210. Execution of the sequences of instructions contained in main memory 2206 causes processor 2204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 2204 for execution. Such a medium may take many forms, including but not limited to, non-volatile media, volatile media, and transmission media. Non-volatile media includes, for example, optical or magnetic disks, such as storage device 2210. Volatile media includes dynamic memory, such as main memory 2206. Transmission media includes coaxial cables, copper wire and fiber optics, including the wires that comprise bus 2202. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 2204 for execution. For example, the instructions may initially be carried on a magnetic disk of a remote computer. The remote computer can load the instructions into its dynamic memory and send the instructions over a telephone line using a modem. A modem local to computer system 2200 can receive the data on the telephone line and use an infra-red transmitter to convert the data to an infra-red signal. An infra-red detector can receive the data carried in the infra-red signal and appropriate circuitry can place the data on bus 2202. Bus 2202 carries the data to main memory 2206, from which processor 2204 retrieves and executes the instructions. The instructions received by main memory 2206 may optionally be stored on storage device 2210 either before or after execution by processor 2204.

Computer system 2200 also includes a communication interface 2218 coupled to bus 2202. Communication interface 2218 provides a two-way data communication coupling to a network link 2220 that is connected to a local network 2222. For example, communication interface 2218 may be an integrated services digital network (ISDN) card or a modem to provide a data communication connection to a corresponding type of telephone line. As another example, communication interface 2218 may be a local area network (LAN) card to provide a data communication connection to a compatible LAN. Wireless links may also be implemented. In any such implementation, communication interface 2218 sends and receives electrical, electromagnetic or optical signals that carry digital data streams representing various types of information.

Network link 2220 typically provides data communication through one or more networks to other data devices. For example, network link 2220 may provide a connection through local network 2222 to a host computer 2224 or to data equipment operated by an Internet Service Provider (ISP) 2226. ISP 2226 in turn provides data communication services through the world wide packet data communication network now commonly referred to as the “Internet” 2228. Local network 2222 and Internet 2228 both use electrical, electromagnetic or optical signals that carry digital data streams. The signals through the various networks and the signals on network link 2220 and through communication interface 2218, which carry the digital data to and from computer system 2200, are exemplary forms of carrier waves transporting the information.

Computer system 2200 can send messages and receive data, including program code, through the network(s), network link 2220 and communication interface 2218. In the Internet example, a server 2230 might transmit a requested code for an application program through Internet 2228, ISP 2226, local network 2222 and communication interface 2218.

The received code may be executed by processor 2204 as it is received, and/or stored in storage device 2210, or other non-volatile storage for later execution. In this manner, computer system 2200 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

### REFERENCES:

[AGGR92] M. Agosti, G. Gradenigo, and P. G. Marchetti. “A hypertext environment for interacting with large textual databases.” Information Processing & Management, 28(3):371-387, 1992.

[AMIT98] Amit Bagga. “Analysis of the MUC-7 Information Extraction Task.”. In Proceedings of the Seventh Message Understanding Conference (MUC-7), April 1998.

[BAFU96] J. R. Bach, C. Fuller, A. Gupta, A. Hampapur, B. Horowitz, R. Jain, and C.F. Shu. The virage image search engine: An open framework for image management. In Proceedings of SPIE, Storage and Retrieval for Still Image and Video Databases IV, pages 76-87, San Jose, Calif., USA, February 1996

[BRIL95] Eric Brill, “Transformation-Based Error-Drive Learning and Natural Language Processing: A Case Study in Part of Speech Tagging”, Computational Linguistics, December '95

[CAGA92] Cahill, L. J., Gaizauskas, R., and Evans, R. (1992) “POETIC: A Fully-Implemented NL System for Understanding Traffic Reports” In Fully-Implemented Natural Language Understanding Systems: Proceedings of the Trento Workshop, Mar. 30, 1992, pp. 86-99, IWBS Report No. 236, IBM Institute for Knowledge Based Systems, Heidelberg, 1992.

[JOJO95] John Aberdeen, John Burger, David Day, Lynette Hirschman, Patricia Robinson and Marc Vilain. “MITRE: Description of the Alembic System as Used for MUC-6”. Proceedings of the Sixth Message Understanding Conference (MUC-6), November 1995.

[JUHE98] Junghoo Cho, Hector Garcia-Molina, and Larry Page. “Efficient web crawling through URL ordering.” In Proceedings of the Seventh International World Wide Web Conference (WWW 7), 1998.

[RIBE99] Ricardo Baeza-Yates and Berthier Ribeiro-Neto. “Modem Information Retrieval”. Addison-Wesley Longman Publishing Company, 1999.

[SELA98] Sergey Brin and Lawrence Page. “The anatomy of a large-scale hypertextual web search engine.” In Proceedings of the Seventh International World Wide Web Conference, 1998.

[SHAN00a] Shankar Narayan, “The effectiveness of QAISR based information retrieval engines”, Sep. 19, 2000

[SHGA95] N.Shivakumar, H. Garcia-Molina, SCAM: A Copy Detection Mechanism for Digital Documents. Proceedings of the 2nd International Conference on Theory and Practice of Digital Libraries, Austin, Texas, 1995.

[WIFR94] William S. Cooper, Fredric C. Gey, and Aitoa Chen. “Probabilistic retrieval in the TIPSTER collections: An application of staged logistic regression.” In Donna Harman, editor, Proceedings of the Second Text Retrieval Conference TREC-2, pages 57-66. National Institute of Standards and Technology Special Publication 500-215, 1994.

1. A method for retrieving information on a computer system, the method comprising the computer implemented steps of:
receiving input representing questions and information sources that are associated with said questions;
generating metadata records that associate said questions with said information sources, wherein each metadata record of said metadata records includes:
question metadata representing a question, and
a location of the information source associated with said question;
storing said metadata records in one or more files on static storage devices of one or more servers connected to a network;
said one or more servers receiving a question input over said network, said question input representing a given question;
said one or more or more servers transforming said question input into transformed input that may be used to look-up metadata records;
said one or more servers selecting a subset of metadata records based on said transformed input and the question metadata of each metadata record of said subset; and
transmitting over said network to a client a list identifying each member of said subset and the location of said each member.
